(19) United States
(12) Patent Application Publication
(10) Pub. No.: US 2012/0278741 A1
(43) Pub. Date: Nov. 1, 2012

(54) METHOD AND SYSTEM FOR CONFIGURING WEB ANALYSIS AND WEB TESTING

(76) Inventor: Justin Garrity, Portland, OR (US)

(21) Appl. No.: 13/410,253

(22) Filed: Mar. 1, 2012

Related U.S. Application Data
(60) Provisional application No. 61/448,090, filed on Mar. 1, 2011.

(51) Int. Cl. G06F 3/01

(52) U.S. Cl. 715/760

(57) ABSTRACT

The current application is directed to methods and systems for configuring web sites and web-analysis and web-testing systems for real-time analysis and testing of web sites. The configuration methods incorporated into the services include interactive configuration, dynamic reconfiguration, and auto-configuration.

### CROSS-REFERENCE TO RELATED APPLICATION

This application claims the benefit of Provisional Application No. 61/448,090, filed Mar. 1, 2011.

### TECHNICAL FIELD

The current application is related to web sites and web-site-based businesses and organizations, and, in particular, to a method and system for configuring a web site and web-site analysis and/or testing service in order to collect data that can be subsequently used to analyze the web site.

### BACKGROUND

During the past 20 years, the development of the hypertext markup language (“HTML”) and web browsers has led to the creation and development of whole new industries and businesses, including Internet retailing of goods and services, search-engine services, electronic encyclopedias, direct retailing and distribution of multi-media content and software, social-networking services, and a variety of additional industries and businesses. Many businesses are based on a web site, a collection of interlinked web pages that are provided to web-site users from a web server, generally one or more servers or higher-end computer systems that receive web-page requests from users via the Internet and respond to the requests by transmitting, to requesting users, HTML files that encode web pages displayed by browser applications executing on users' computers.

The creation and maintenance of an effective web site may involve engineers and professionals of a number of different disciplines, including software engineers and web-page developers, artists, writers, and other content creators, and analysts who monitor a web site and evaluate the effectiveness of the web site on an on-going basis. As one example, an Internet retailer may spend millions of dollars in retailing web-site design and development, using teams of engineers, developers, and content creators, and may undertake continuous evaluation of retail results associated with a retailing web site, using marketing professionals and other analysts, in order to understand operational characteristics of, and use patterns associated with the web site, to design new and additional functionality for the web site, and to attempt to identify potential changes to the web site that can be fed back to the designers and content creators in order to optimize the web site with respect to specific goals and constraints. For an Internet retailer, the total amount of sales generated from a retailing web site, the overall number of visitors who navigate past the home page of a website, the number of redirections to allied web sites using links provided on pages of the web site, and many other metrics may comprise the goals for web-site optimization. Constraints may include human and financial resources needed to effect the changes to the web site, the time needed to make the changes, compatibility of added features with widely used browsers and browser plug-in programs, and many other such constraints.

As with any type of live or run-time analysis testing, analysis and testing undertaken by marketing professionals and analysts may represent, to a web-site-based business or information service, large expenditures in money, time, and other resources. Furthermore, live analysis and live testing may unintentionally negatively impact the web site, by creating unintended interruptions, errors, and access delays for customers. Costs and potential liabilities of web-site analysis and web-site testing may therefore constitute a significant additional constraint for web-site optimization. For this reason, web-site developers and owners seek cost-effective, time-and-resource-economical, and minimally intrusive methods and systems for web-site analysis and web-site testing that can provide a sound statistical basis for web-site analysis, testing, and optimization.

### SUMMARY

The current application is directed to methods and systems for configuring web sites and web-analysis and web-testing systems for real-time analysis and testing of web sites. The configuration methods incorporated into the services include interactive configuration, dynamic reconfiguration, and auto-configuration.

### BRIEF DESCRIPTION OF THE DRAWINGS

FIG. 1 provides a context for discussion of the currently disclosed methods and systems.

FIG. 2 shows a simple, exemplary web page.

FIG. 3 shows the contents of an HTML file that encodes the exemplary web page shown in FIG. 2 and that includes simple modifications.

FIG. 4 provides a tree-like representation of the contents of the exemplary HTML file shown in FIG. 3.

FIG. 5 illustrates a simple web site comprising seven web pages.

FIGS. 6-7 illustrate factors, factor levels, and test design.

FIG. 8 illustrates the concept of segments in testing of web pages.

FIG. 9 illustrates the data and data structures that define tests, test runs, and experiments.

FIG. 10 illustrates the nature of the statistics, or test results, that are collected for a particular test run.

FIG. 11 illustrates a testing environment that carries out web-site testing.

FIGS. 12A-H illustrate a general method and system for web-site testing.

FIGS. 13A-H provide control-flow diagrams for a web-site test service.

FIG. 14 shows the HTML modifications used to virtually incorporate a testing service into a web site.

FIG. 15 provides an exemplary script library downloaded service.

FIG. 16 illustrates the types of data that can be acquired and stored in an electronic memory or mass-storage device regarding a web site or collection of web sites that are, or are intended to be, the target of analysis or testing by a web analysis or web testing service.

FIG. 17 illustrates one type of real-time information that may be acquired and stored in electronic memory or mass-storage device with regard to operation of a web site.

FIGS. 18-20 illustrate an example interactive-configuration session by which a user of a web-analysis or web-testing service configures one or more analyses or testing sessions.

FIGS. 21 and 22 provide flow-control diagrams that illustrate interactive configuration of a web site for analysis and/or testing.

FIG. 23 illustrates an example dynamic-reconfiguration user interface to facilitate dynamic reconfiguration.

FIGS. 24-25 provide control-flow diagrams that illustrate dynamic reconfiguration.

FIG. 26 illustrates the product of analysis of the third user interactions and other analyses of the logged data and other data collected during web-site operation discussed above with reference to FIG. 17.

FIG. 27 provides a control-flow diagram for an auto-configuration routine that may be periodically or continuously run by an analysis and/or testing service.

### DETAILED DESCRIPTION OF THE INVENTION

The current application is directed to configuring web sites and analysis and/or testing services for live, real-time analysis and/or testing of web site. There are many different types of web sites and web-site servers that can be analyzed and tested. In the following first subsection, in order to provide a context for the discussion of configuration that follows, a generalized web site is tested by an analysis-and/or-testing service. This discussion is focused on testing and optimization, but the same tools used to instrument web pages for testing can be used to instrument web pages for data collection to facilitate web-site analysis. It should be noted, at the onset, that the disclosed methods and systems are not restricted to a particular class or type of web site, but are generally applicable to a wide variety of different types of web sites and web-site based businesses and organizations. For example, the disclosed methods and systems can be applied to configure testing and to analysis of the effectiveness of an Internet-commerce web site, but can also be applied to non-commercial information-distribution web sites, including on-line encyclopedias, to non-commercial social-networking web sites, to search-engine service providers, and many other types of web sites and web-site-based businesses. It should also be noted, at the onset, that the disclosed methods and systems are primarily directed to configuring minimally-intrusive, cost-effective, and time-and resource-efficient live, on-line experimentation and statistics collection. The statistics and data collected by the disclosed methods and systems can be subsequently analyzed by a variety of different analytics packages in order to generate various types of reports that provide information to web sites that can be used for optimization. The analytical analysis and reporting may be executed on analysis-and/or-testing-service computer facilities, or on remote computing facilities.

### Web-Site-Testing Context for Following Discussion

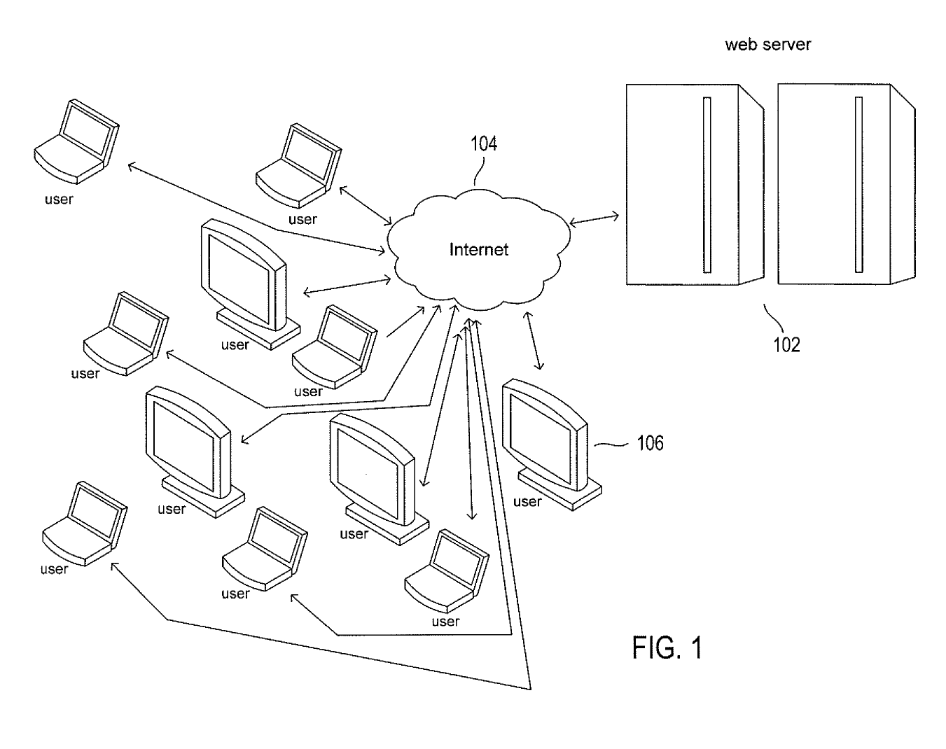

FIG. 1 provides a context for discussion of the currently disclosed methods and systems. In FIG. 1, a server 102, comprising one or more servers and/or other types of computer systems, transmits HTML-encoded web pages through the Internet 104 to a large number of user or customer computers, including as user computer 106. As discussed above, the web server may be owned and operated by an Internet retailing organization, an information-distribution system, a social-networking system, or another type Internet-based transactional or content-distribution system. In general, the web server runs continuously, at all times during the day and night, providing HTML-encoded web pages and, usually, additional types of information and services, including downloads of executable code, scripts, and other such information for specific types of web-based applications.

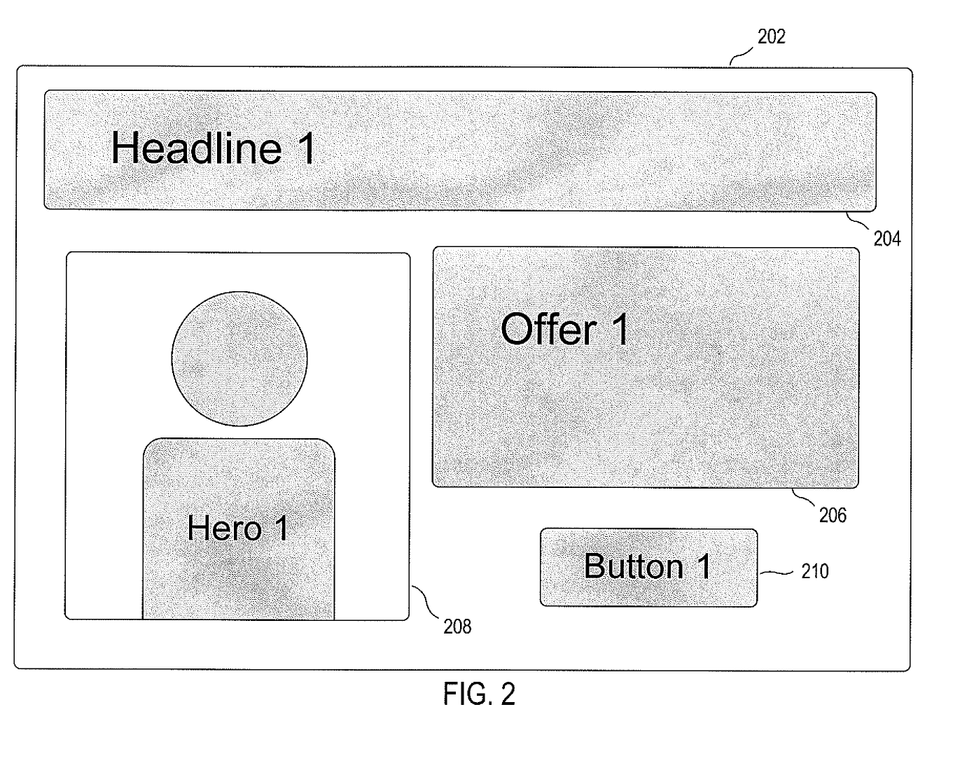

FIG. 2 shows a simple, exemplary web page. A web page is described by an HTML file, discussed below, which is processed by a web browser executing on a computer in order to generate a web page, as shown in FIG. 2, that is displayed to a user on a display device. The exemplary web page 202 includes a headline graphic 204, an offer graphic 206, a hero graphic 208, and a button graphic 210. The exemplary web page is subsequently discussed in the context of tests and experiments in which altered versions of the web page are provided to users of the web server that serves the web page in order to test the effects of modifications to the web page.

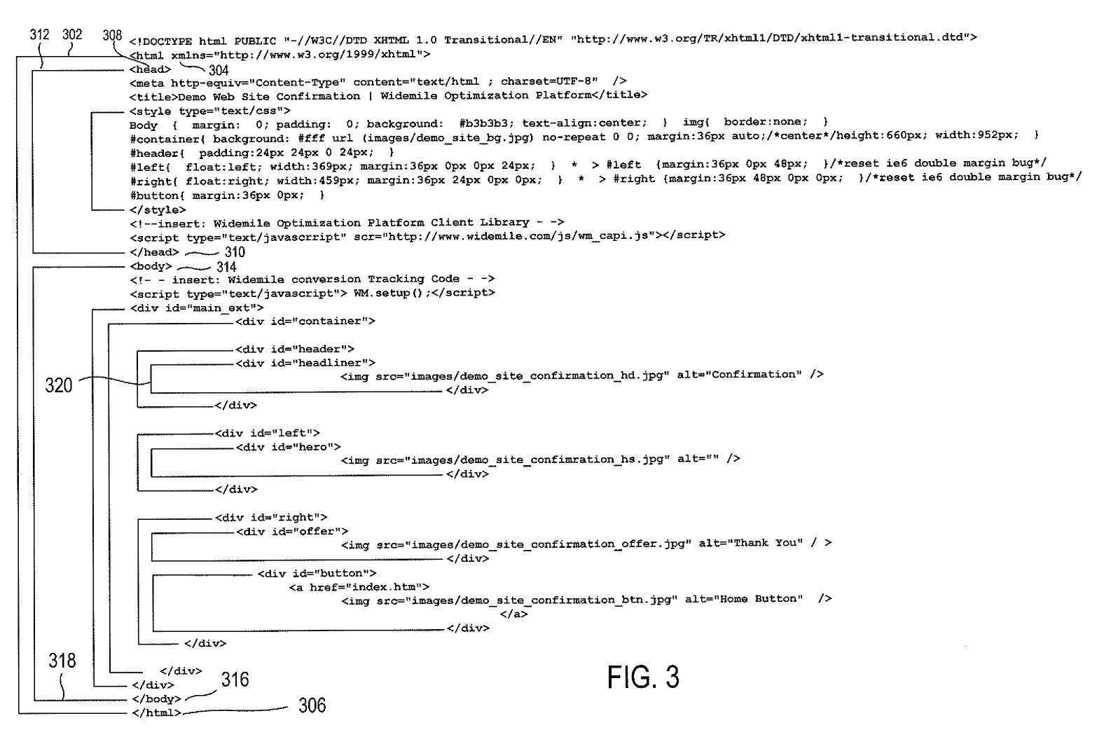

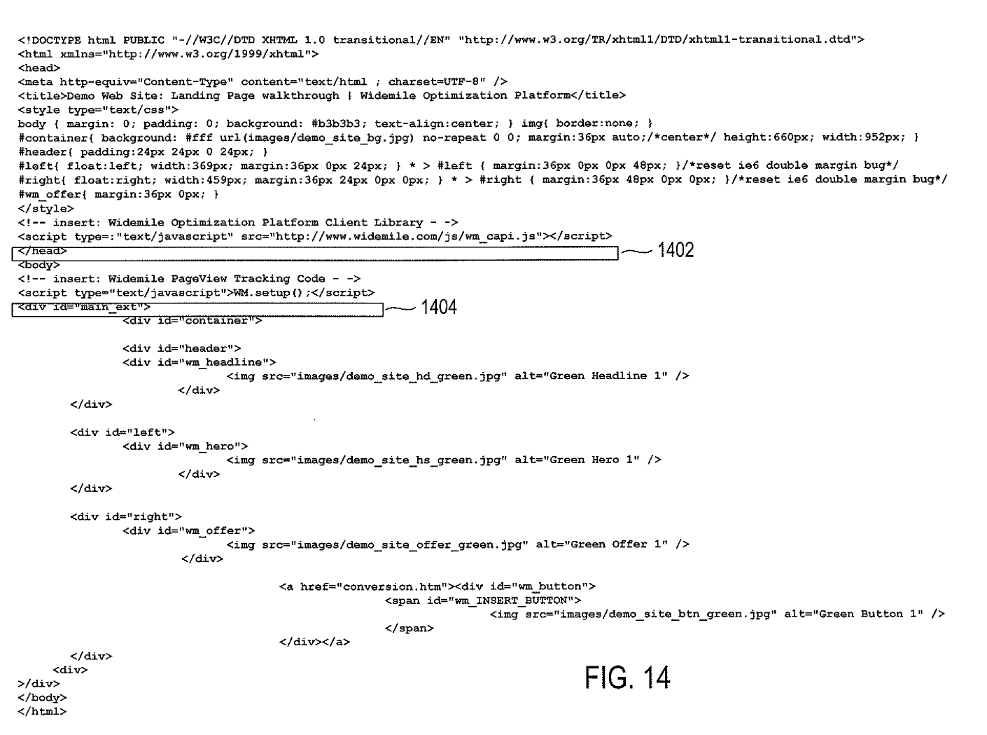

FIG. 3 shows the contents of an HTML file that encodes the exemplary web page shown in FIG. 2 and that includes simple modifications. The modifications, used to virtually incorporate an analysis-and/or-testing service into a website, are discussed below, with reference to FIG. 14.

A complete discussion of HTML is beyond the scope of the current discussion. In FIG. 3, portions of the HTML file are correlated with features in the displayed web page shown in FIG. 2. In addition, general features of HTML are illustrated in FIG. 3. HTML is hierarchical, in nature. In FIG. 3, double-headed arrows, such as double-headed arrow 302, have been drawn to the left of the HTML code in order to illustrate tags and tag scoping within the HTML file. In general, HTML statements are delimited by a pair tags, and are hierarchically organized by scope. For example, an outermost statement begins with a first tag of a tag pair that begins with the text “<html xmlns=” (304 in FIG. 3) and ends with a last tag of the tag pair that begins with the text “</HTML” (306 in FIG. 3). The scope of outermost statement encompasses the entire HTML code. The double-headed arrow 302 at the left of the HTML code, which represents the scope of this statement, spans the entire HTML file. A second-level that begins with the first tag of a tag pair “<head>” 308 and ends with the last tag of the tag pair “</head>” 310 spans a first portion of the HTML file, as indicated by double-headed arrow 312, and a second statement bounded by the first and last tags of a tag pair “<body>” 314 and “</body>” 316 span a second portion of the HTML file, indicated by double-headed arrow 318. By examining the tags within the exemplary HTML file, shown in FIG. 3, and the double-headed indications of the scope of tag-delimited statements, the hierarchical nature of HTML can be readily appreciated.

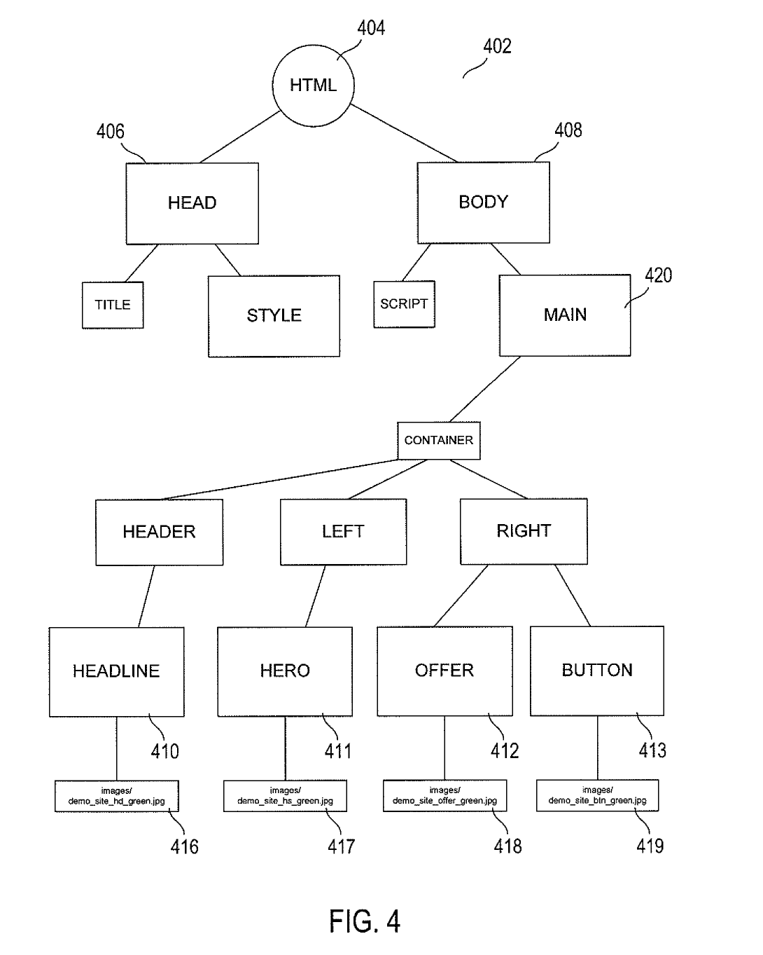

FIG. 4 provides a tree-like representation of the contents of the exemplary HTML file shown in FIG. 3. The tree 402 shown in FIG. 4 is constructed from the double-headed arrows that annotate the HTML code, in FIG. 3, that span the scopes tag-delimited statements in the exemplary HTML file. For example, the root node 404 corresponds to double-headed arrow 302, and the second level “head” 406 and “body” 408 nodes correspond to double-headed arrows 312 and 318 in FIG. 3, respectively. Note that, at the very bottom of the tree representation of the HTML file, shown in FIG. 4, the four leaf nodes 416-419 represent the four features 204, 206, 208, and 210 of the displayed web page encoded by the exemplary HTML file, shown in FIG. 2. Each of these nodes is essentially a reference to an image file that contains a jpeg image of the corresponding web-page feature. The head statement, represented by node 406 in FIG. 4, includes formatting information, references to highest-level resource-location directories, and a great deal of additional information that is used by a browser to plan construction of a displayed web page. The body statement, represented by node 408 in FIG. 4, includes references to image files, text, and other features that are rendered by the browser into displayed features of the web page. Intermediate nodes include identifiers, particular met-data information, and references to scripts that are downloaded and run by the web browser during web-page rendering and/or display.

As a specific example, node 416, a direct and only descendant of the node labeled “headline” 410 in FIG. 4, corresponds to the headline feature 204 displayed in the exemplary web page shown in FIG. 2. This node also corresponds to double-headed arrow 320 in FIG. 3. The statement “<img src=”images/demo_site_hd_green.jpg” indicates that the displayed object is encoded as a jpeg image “demo_site_offer_green.jpg” that can be found in a file-system sub-directory “images.”

In order to transform an HTML file into a displayed web page, a web browser constructs a tree-like binary-encoded data object referred to as a “document object model” (“DOM.”) The exact contents and structure of a DOM is beyond the scope of the present discussion However, disclosed methods and systems rely on standardized DOM-editing interfaces that provide routines to identify nodes and subtrees within a DOM and to edit and modify identified nodes and subtrees. Once a browser has created a DOM from the exemplary HTML file shown in FIG. 3, DOM-editing routines can be used to locate the node in the DOM corresponding to the node “headline” 410 in FIG. 4 and replace or modify that node to reference a different image. Following modification, the web browser would then display a modified web page in which the headline image 204 in FIG. 2 is replaced by a different image. To effect more dramatic changes, an entire subtree of a DOM, such as the subtree rooted by a node corresponding to the node “right” 420, can be removed or replaced, to change groups of display features. While the disclosed methods and systems, discussed below, uses DOM tree modification techniques, other types of modification techniques provided by interfaces to other types of binary representations of web pages may be used, in alternative methods and systems. The DOM is only one of many possible binary representations that may be constructed and employed by web browsers.

Another feature of the exemplary HTML file shown in FIG. 3 is that the various features displayed in FIG. 2 are, in HTML, wrapped by tag-delimited identifiers. For example, the “wm_headline” tag indicated by double-headed arrow 320 and by node 410 in FIG. 4 is an identifier for the headline-image-reference statement 322. Alphanumeric identifiers, such as the identifier “wm_headline,” are introduced into an HTML file in order to give easy-to-understand and easy-to-use labels or handles for various objects, particularly objects that correspond to displayed features in a web page. Although objects can be easily identified in this manner, other methods for identifying objects within an HTML file, as well as corresponding nodes of DOM trees and other such binary representations of a rendered page, can be used to reference display objects.

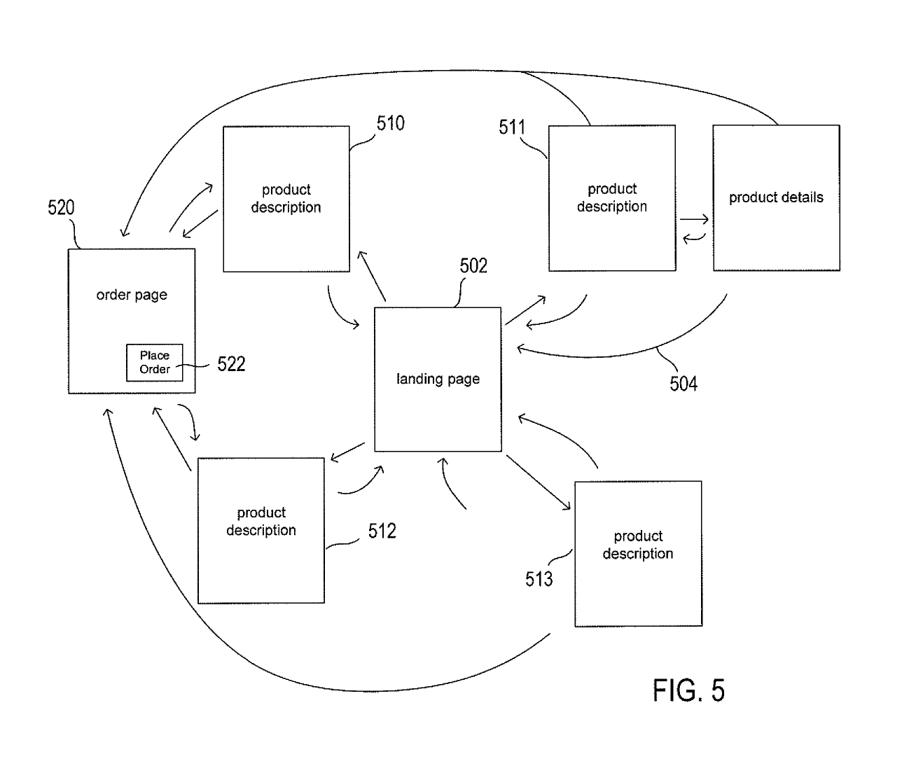

FIG. 5 illustrates a simple web site comprising seven web pages. Each web page, such as web page 502, is represented by a rectangle in FIG. 5. Curved arrows, such as curved arrow 504, indicate navigational paths between the web pages. Accessing the web site illustrated in FIG. 5, a user generally first accesses a landing page 502 as a result of clicking a link provided by another web page, such as a web page provided by a search engine, or provided in a list of bookmarked links by a web browser. The landing page is often, but not necessarily, a home page for the website. A home page is a central portal for access to all of the remaining web pages in the web site. In general, a user navigates through the web site by clicking on displayed links embedded in web pages. For example, the web site illustrated in FIG. 5 is a retailing web site. The landing page provides links to four different pages 510-513 that provide product descriptions for four different products. A user, after viewing the landing page 502, may click a link in order to navigate to a display of a product-description page 510. In the exemplary web site shown in FIG. 5, a user may subsequently navigate from a product-description page or product-details page to a central order page 520 that contains a button or feature 522 to which the user can input a mouse click in order to order one or more products. In certain cases, web sites may comprise a single page and, in other cases, a web site may comprise tens to hundreds or more pages, linked together in a network-like graph describing various navigational paths between web pages.

An example application of web-site testing would be to monitor access, by users, of the web pages shown in FIG. 5 in order to attempt to determine how often users end up navigating to the order page and clicking the place-order button 522. One might then modify one or more of the pages, and again monitor users' access to the pages and subsequent input to the place-order button 522. In this way, by testing collective user response various alternative web pages, web-site developers and managers may be able to determine an optimal set of web pages that provides the highest ratio of inputs to the place-order button 522 to user accesses of the landing page 502. In testing parlance, clicking the place-order button 522, in the exemplary web site shown in FIG. 5, is, in this example, considered to be a conversion event. One goal of optimizing the web site might be to increase the percentage of users clicking on the place-order button 522 after initially accessing the landing page 502. However, conversion events may be arbitrarily defined, and there may be multiple conversion events for a particular web site. Optimization of a web site may also involve multiple, often at-least partially contradictory goals. One goal may be to increase the number of accesses to any page other than the landing page by users who have initially accessed the landing page. Another goal may be to increase total accesses to the landing page, regardless of subsequent page accesses by users accessing the landing page. Another goal may be to obtain maximum possible conversion rates, even at the expense of decreasing the overall rate of page accesses.

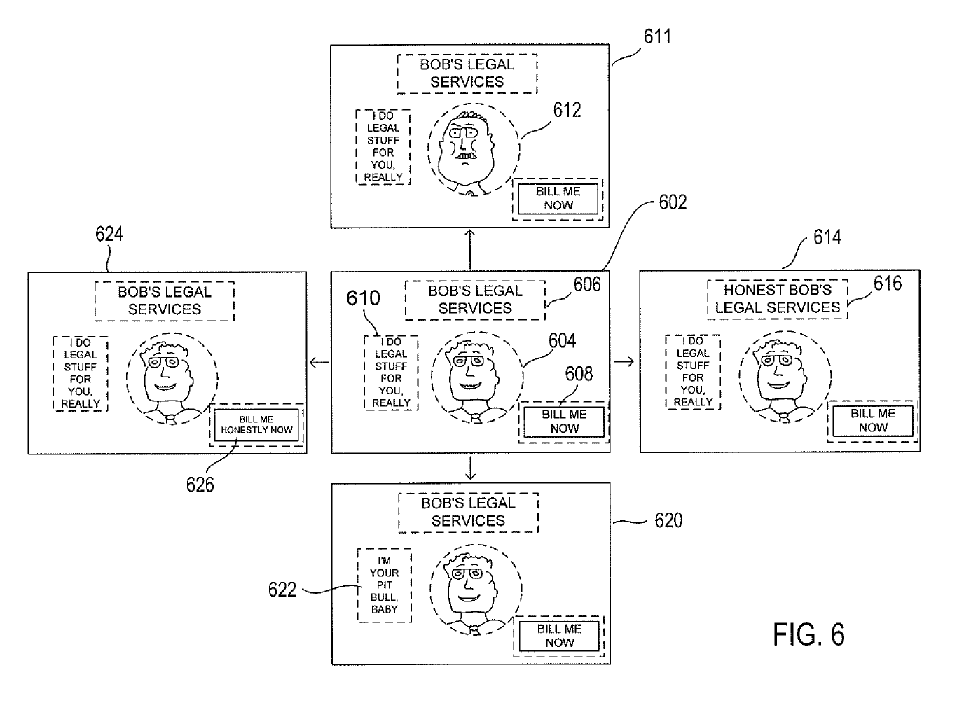

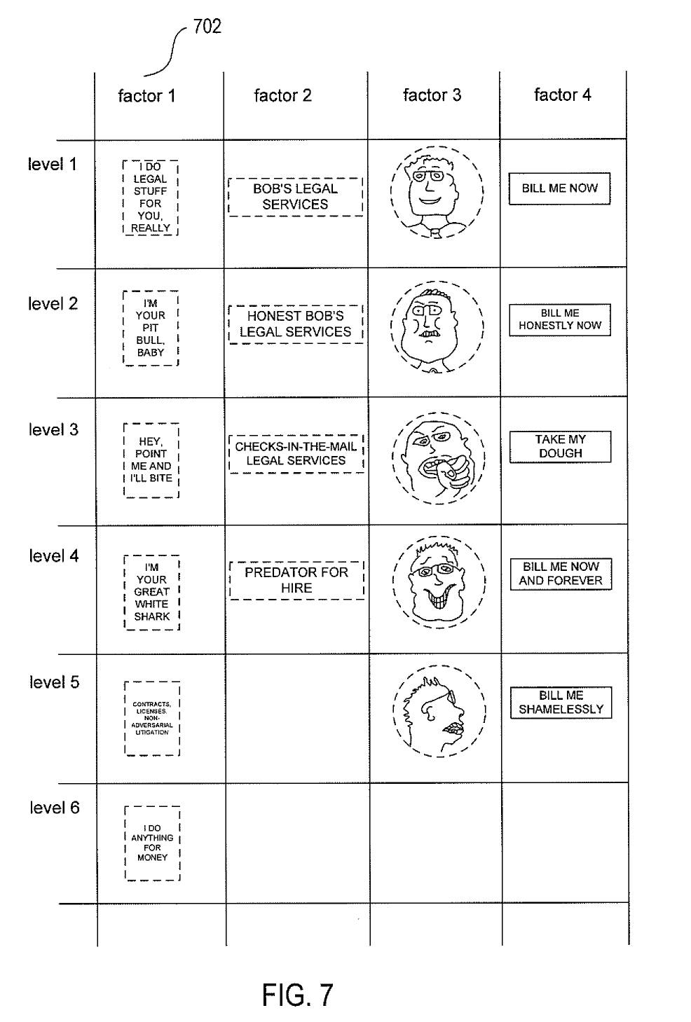

FIGS. 6-7 illustrate factors, factor levels, and test design. In FIG. 6, an initial, prototype web page 602 is shown. A web-site owner or developer may decide to systematically alter the prototype web page in order to test the effects of the systematic alterations, so that alterations that appear to maximize goals can be made to the web page in order to optimize the web page. The prototype web page includes a portrait image 604, a title 606, a user-input feature 608, and an informational message 610. A systematic tester may decide to alter each of these web-page features, one-at-a-time, in order to determine the effects of the altered features on measured user response. For the web page shown in FIG. 6, the measured user response, or conversion event, would likely be user input to the user-input feature 608. As shown in FIG. 6, a tester may devise a first test web page 611 in which the prototype image 604 is replaced with a different image 612. The tester may devise a second test page 614 in which the title feature 606 is replaced with a different title feature 616. Similarly, the tester may devise a third test page 620 in which the informational message 610 of the prototype web page is replaced with a different informational message 622. Finally, the tester may create a fourth test web page 624 in which the user-input feature 608 of the prototype web page is replaced with a differently labeled user-input feature 626. The systematic tester may change a single feature, in each of the four test pages, in order to judge the effect of changing that feature in isolation from any other changes to the web page that might be contemplated. However, the strictly one-feature-change-at-a-time method would fail to provide data for the effects of various combinations of changes, such as changing both the headline and a portrait and, moreover, would require significant developer time and effort.

FIG. 7 illustrates a related approach to the testing approach discussed with reference to FIG. 6. In FIG. 7, the tester has prepared a table of factors and factor levels. Each factor in the table is represented by a column, such as the first column 702 corresponding to factor 1. Each factor is a feature, or group of related features, on a displayed web page that the tester wishes to alter in order to determine whether or not to alter the feature in order to optimize the web page with respect to one or more optimization goats. The various alternatives for each factor are referred to as levels. Thus, for example, factor 1, represented in the table by column 702, corresponds to the information message (610 in FIG. 6), for which the tester has devised six different alternatives, each corresponding to one of six different levels associated with that factor. The tester has devised four alternatives for factor 2, the title feature (606 in FIG. 6), five alternatives for factor 3, the portrait feature (604 in FIG. 6), and five alternatives for the fourth factor, the user-input feature (608 in FIG. 6). Then, having specified the factors, or web-page features, to be altered, and the various different alternatives for each feature, the tester might try generating all possible test pages corresponding to all possible combinations of level values for the factors in order to test the different alternative web pages to determine an optimal set of four levels corresponding to optimal alternatives for the four factors. Unfortunately, an exhaustive, combinatorial test, in most cases, is not feasible. Even for the very simple example of FIGS. 6 and 7, there are 1260 different alternative pages, including the prototype page, which can be constructed by varying between one and four factors according to the variations, or levels, provided in the table provided in FIG. 7. In general, for the statistics collected from testing to have significance, a sufficient number of tests need to be conducted so each of the different test pages is displayed a relatively large number of times during the test. In the example of FIGS. 6 and 7, each different alternative web page among the 1260 possible alternative web pages may need to be displayed hundreds or thousands of times to users in order to accumulate sufficient test data to make valid statistics-based judgments. In many cases, the number of factors and number of levels for each factor may be far larger than in the simple example shown in FIGS. 6 and 7.

The variations of factors, or levels, may include changes in content, display size, display color, object position in the displayed image, or many other different types of changes. Again, as discussed above, a factor may include multiple display features.

Because of the general infeasibility of full, exhaustive, combinatorial testing of all possible web-page variations, certain methods and systems use an experimental-design method referred to as “the orthogonal-array method.” This method devises a non-exhaustive test strategy that nonetheless gathers sufficient, well-distributed test data in order to make reasonable inferences with regard to the effects of altering the factors in all possible ways. In essence, the orthogonal-array method involves devising a sparse sampling of all possible variations of the web page that provides information about the various dependencies between the different levels of the different features. The orthogonal-array method involves specifying the factors and specifying the levels for each factor for a particular test run, and then, based on the factors and levels for each factor to be tested in a particular test run, devises a set of alternative web pages, by varying the specified factors according to the specified levels, that provide a good basis for collecting statistics for the features to be tested. The orthogonal-array method is well known in testing and statistics. Many additional types of test-design methods may also be used. Whatever test-design technique is employed, each test run defined by clients is associated with a test design that controls generation and distribution of experiments, or modified web pages.

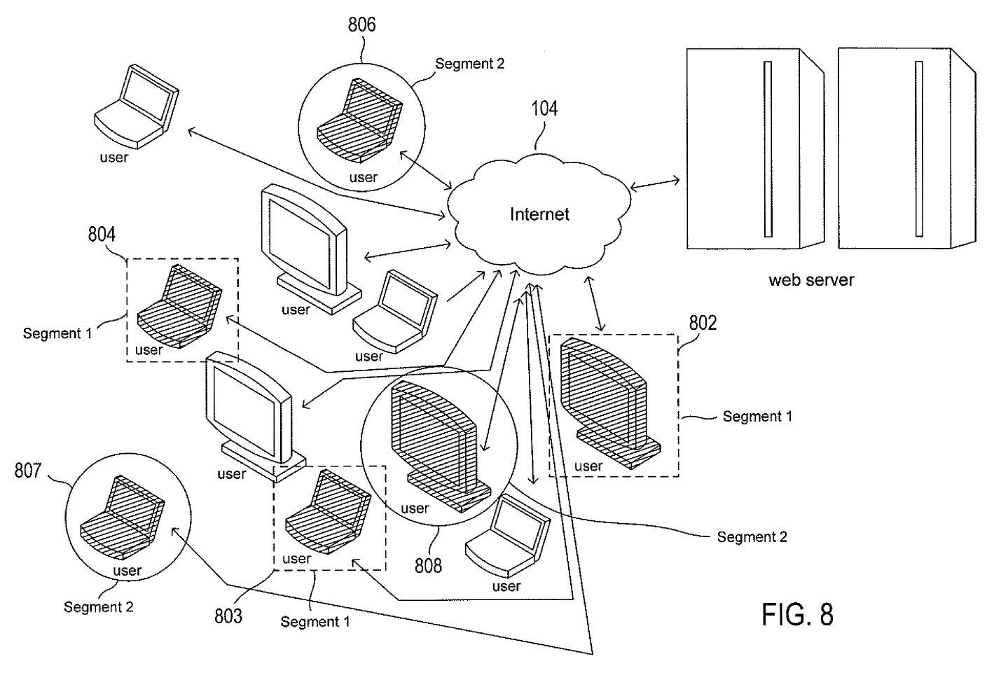

FIG. 8 illustrates the concept of segments in testing of web pages. FIG. 8 shows the web server and users of the web server using the same illustration conventions as used in FIG. 1. However, in FIG. 8, a first set of three users 802-804 are marked as belonging to a first segment, segment 1, and a second set of three users 806-808 are marked as belonging to a second segment, segment 2. During live, real-time testing of web sites, alternative versions of web pages are provided to subsets of the total number of users, or customers, accessing the web server. During a particular test run, altered web pages are provided to a specified segment of users. A segment of users, or customers, can be defined by any of a wide variety of different parameters. For example, a segment of users may be defined by the web page or link by which the users or customers navigated to a test page served by the web server. Segments may be defined by time periods, by the Internet domains through which users access the Internet, or by many other different criteria.

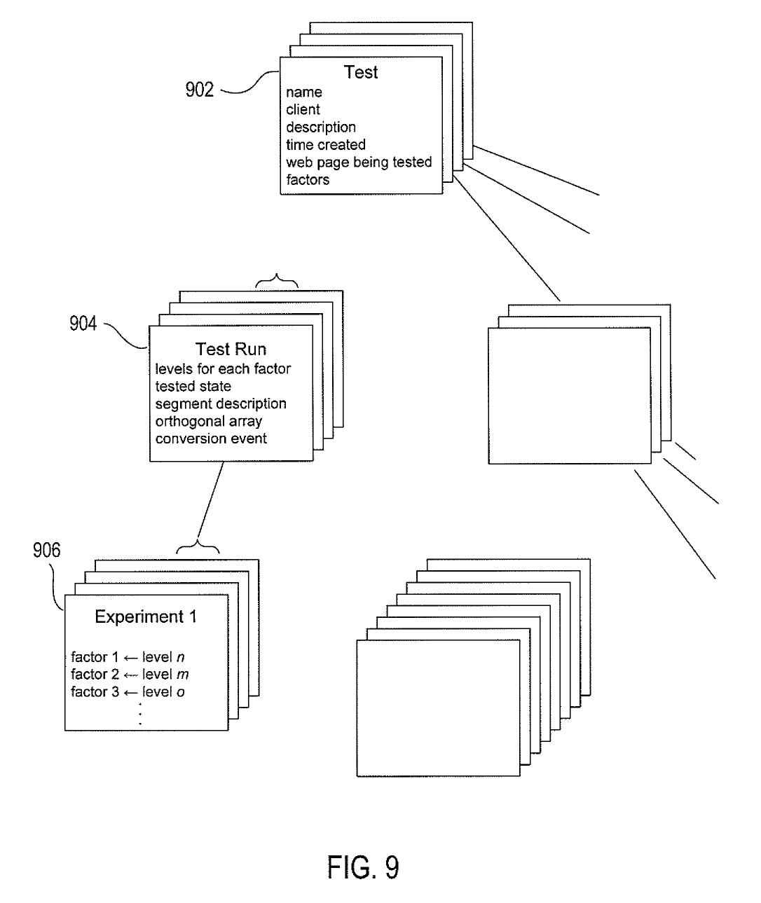

FIG. 9 illustrates the data and data structures that define tests, test runs, and experiments. An analysis-and/or-testing service may, at any given time, carry out a large number of different tests for many different client web-site-based organizations. Each test is defined by a test record, such as test record 902 in FIG. 9. Information contained in the test record includes an alphanumeric name of the test, an identifier for the client on behalf of whom the test has been created, a description of the test, an indication of the time that the test was created, an indication of the web page that is tested by the test, and a list of the factors that may be involved in any particular test run associated with the test. Note that the factors can be specified by the identifiers associated with features or objects displayed in the web page. For example, referring to FIGS. 2-4, a list of factors for a test of the exemplary web page shown in FIG. 2 may include the alphanumeric strings: “wm_headline,” “wm_hero,” “wm_offer,” and “wm_button.”

Any particular test may be carried out over a series of test runs. For example, each test run may be carried out at a different time, with respect to a different segment of users, and may test a different array of features and feature levels. Thus, each test record, such as test record 902 in FIG. 9, may be associated with one or more test-run records, such as test-run record 904 in FIG. 9. Test-run records include information such as the levels to be used for each factor, with the levels specified as URLs, or other references to images and other resources, or as text strings or other data directly displayed by the browser, a current state of the test run, a description of the segment to which the test run is directed, an indication of the particular orthogonal-array basis or other test design for the test run, and an indication of one or more conversion events for the test run. Finally, using the orthogonal-array basis or other test design selected for the test run, a test run is associated with a set of experiments, such as experiment 906 in FIG. 9. Each experiment corresponds to an altered web page that is displayed to users during the test run. An experiment is essentially defined by associating each factor, tested in the test run, with a particular level, or referenced resource, according to a matrix of test pages generated by the orthogonal-array basis or other test design selected for the test run.

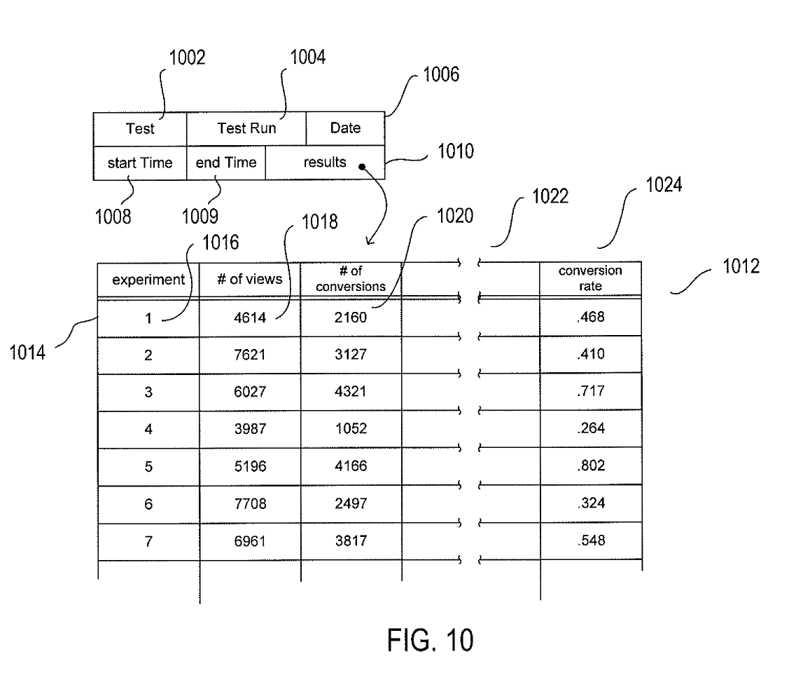

FIG. 10 illustrates the nature of the statistics, or test results, that are collected for a particular test run. The results include indications of the test 1002 and test run 1004, the date on which the test run was conducted 1006, a start time and an end time for the test run 1008-1009, and a reference 1010 to a results table 1012 in which test results are tabulated. The test results table includes a row for each experiment associated with the test run, such as row 1014 in experimental-results table 1012. The row includes an indication of the experiment to which the row corresponds 1016, a count of the number of the times that the page corresponding to the experiment was accessed by a user of an active segment 1018, an indication of the number of times that a user who accessed the test page generated a corresponding conversion event 1020, other similar numerical information in additional columns 1022, and, finally, a computed conversion rate 1024 for each experiment. The test results shown in FIG. 10 are but one example of the type of statistics and data that can be collected during a test run. Different or additional statistics may be collected by different methods and systems, or according to different test configurations created by analysis-and/or-testing-service clients.

There are many different possible ways of testing a web server in order to accumulate test results, discussed above with reference to FIG. 10, for tests defined for particular web pages and factors associated with those web pages, as discussed above with reference to FIG. 9. One method would require the web server to design a test by creating all or a subset of possible alternative test pages and to then develop a test-page-serving system that would execute concurrently with, or as part of, the web server on an intermittent or continuous basis. As discussed above, testing methods and systems that require the web server to develop and run tests may be prohibitively expensive, both in time and resources, for web-site owners or web-site-based organizations. Furthermore, such testing methods can inadvertently cause serious financial losses and other non-financial damage to a web site. For example, were the test pages improperly constructed or served, sales or other activities generated by real-time users may be lost and, in worst cases, the web site could potentially lose business from particular customers and users altogether. Real-time testing additionally involves significant security risks. A malicious hacker or employee might be able to alter the test system to display fraudulent or offensive test pages, for example. Finally, similar to problems encountered in a variety of physical and behavioral systems, poorly or improperly design tests may so perturb the system being tested that the statistics collected from the tests are meaningless or, in worst cases, lead to false conclusions. For example, a poorly designed test engine may introduce significant delays in web-page service to customers or users. As a result, the conversion rate measured during a test run may fall precipitously, not because of particular alterations made to test web pages, but instead because the significant time delay encountered by users for whom the test page is constructed and to whom the test web page is transmitted. For these, and many other reasons, web-site-based-organization test design and execution can be undesirable and, in worst cases, disruptive and damaging to the web-site-based organization.

An alternative approach involves using a third-party analysis-and/or-testing service, in tandem with the web server that serves the web site to be tested. However, simply conducting tests by a third-party server does not guarantee that the many pitfalls and disadvantages discussed above with respect to web-site-based-organization test design and execution are necessarily avoided. In fact, in many cases, the pitfalls and disadvantages discussed in the preceding paragraph may be exacerbated by third-party testing of web sites and web servers. For example, in the ease that a test web page, requested by a customer, needs to be prepared by the third-party server, in response to a request generated by the web site as a result of a user request for the web page being tested, test-page serving may be significantly delayed, deleteriously perturbing the users' interaction with the web server to the point that the test statistics end up meaningless or misleading. As another example, security issues may be compounded by distributing testing tasks between a web-server computer system and a third-parting testing server. Methods and systems employ an array of techniques and features that address these pitfalls and disadvantages, and that provide minimally intrusive and cost-effective testing for web sites and web servers.

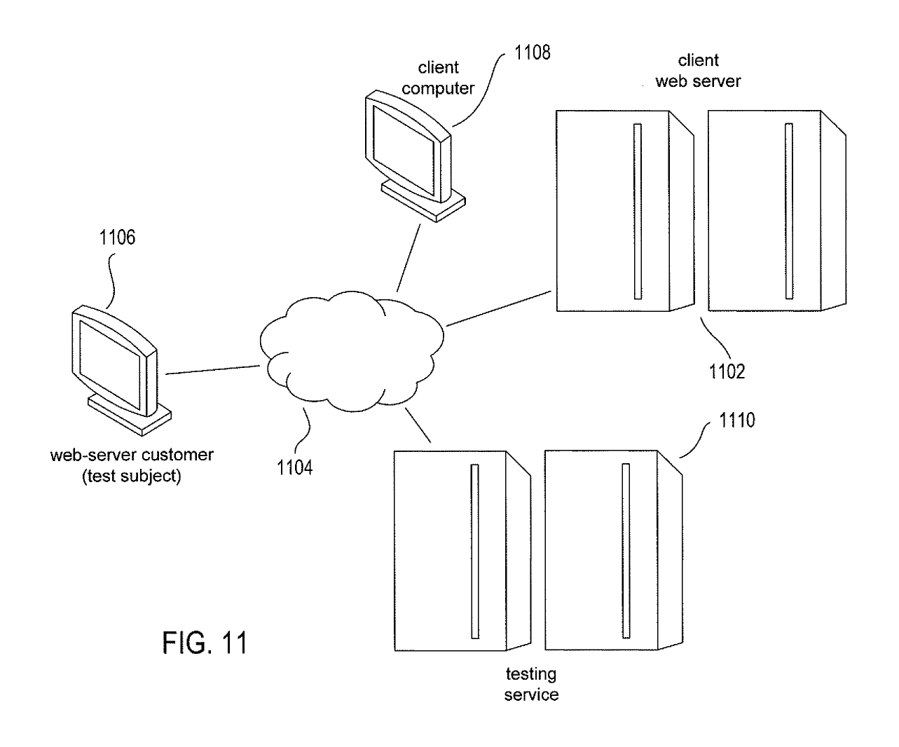

FIG. 11 illustrates a testing environment that carries out web-site testing. In FIG. 11, the web site 1102 is represented as one or more servers or large computer systems that serve web pages through the Internet 1104 to a generally large number of web-site users or customers, including user 1106. The web site or web server is regarded, in the following discussion, as a client web server of the analysis-and/or-testing service. The client web server also includes a client computer 1108 by which the client web-server-based organization can access various third-party analysis-and/or-testing services and web servers through the Internet. Finally, a web-site analysis-and/or-testing service is provided by a distinct server or servers 1110 accessible to the client web server 1102, the web server customer 1106, and client computer 1108 via the Internet 1104.

The analysis-and/or-testing service is used by the client web-site-based organization, referred to as the “client,” below, to design and run real-time, live tests of web pages provided by the client web server to users. The analysis-and/or-testing service may run on the same computer systems as the client web server. In general, the analysis-and/or-testing service is geographically distinct from the client web server, and is concurrently used by multiple, different clients for concurrently executing many different test runs on behalf of the multiple clients.

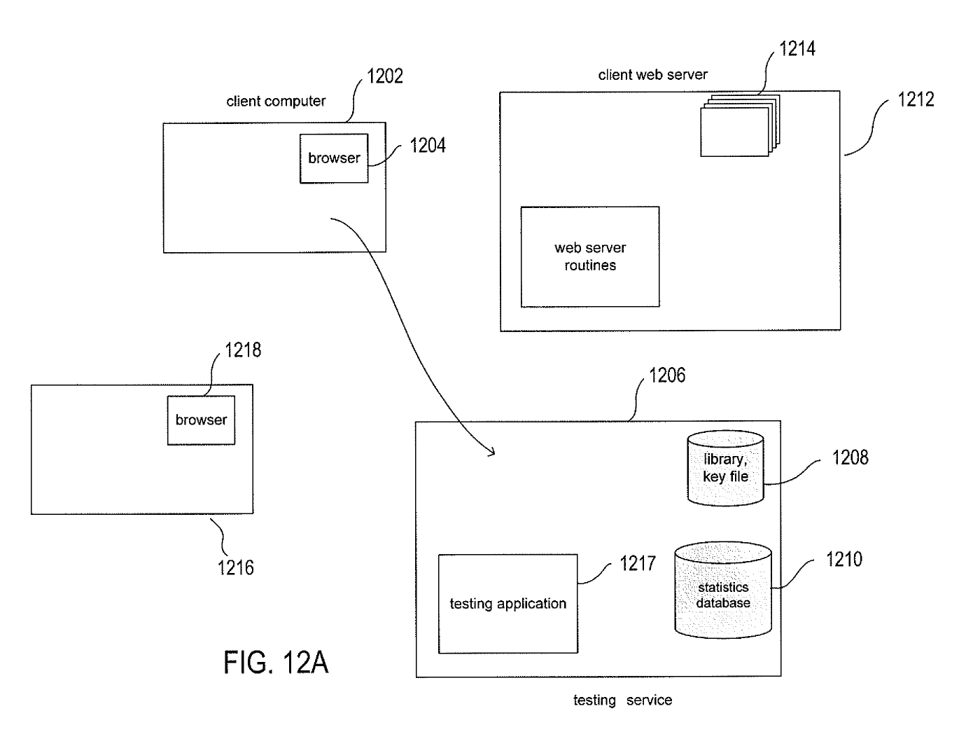

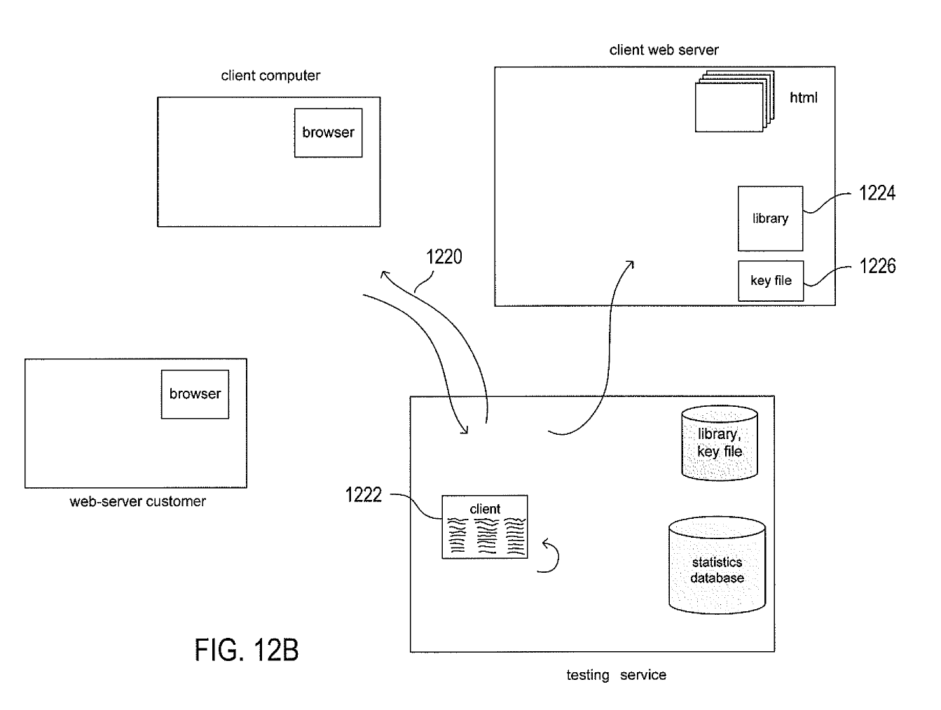

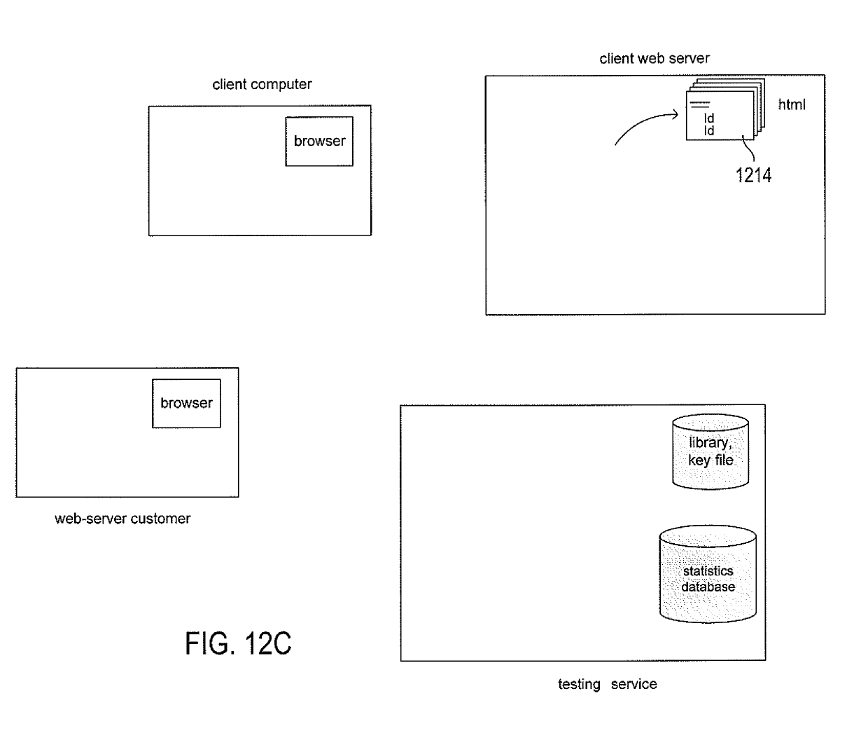

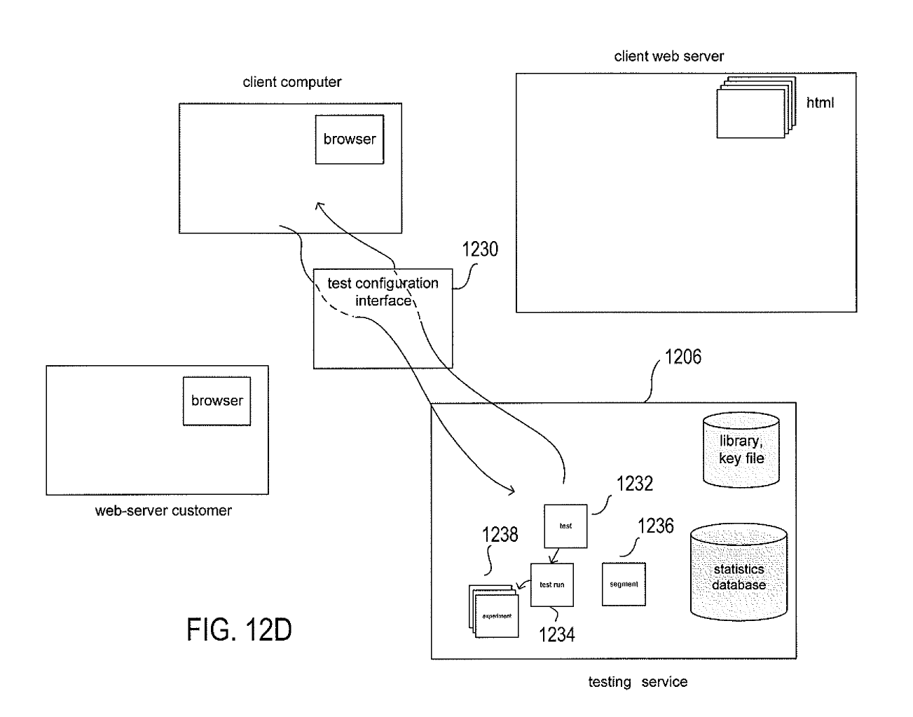

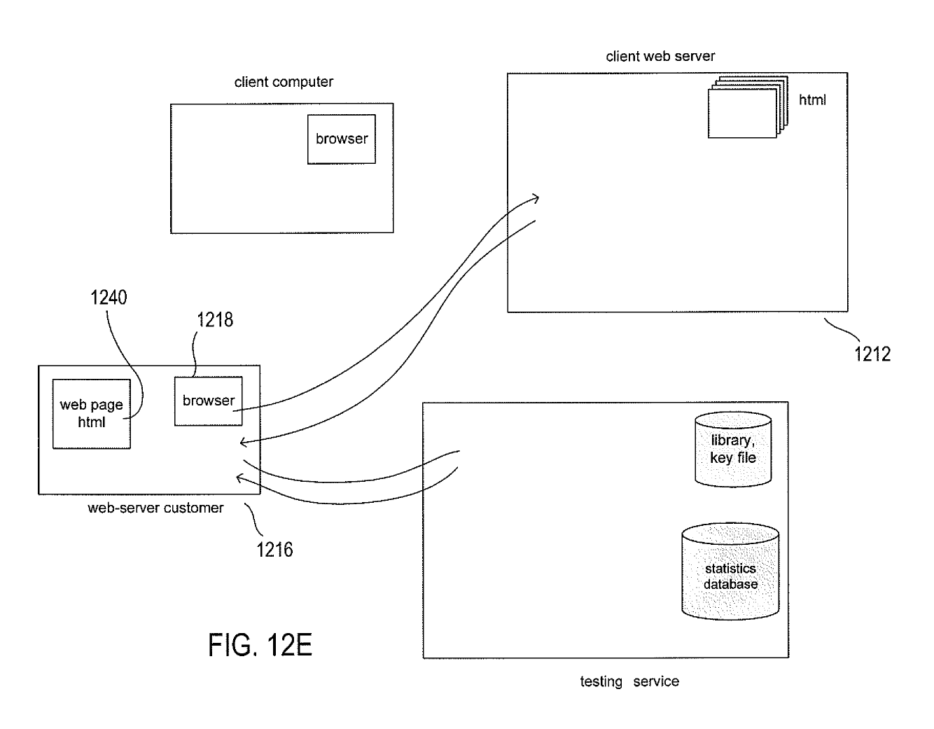

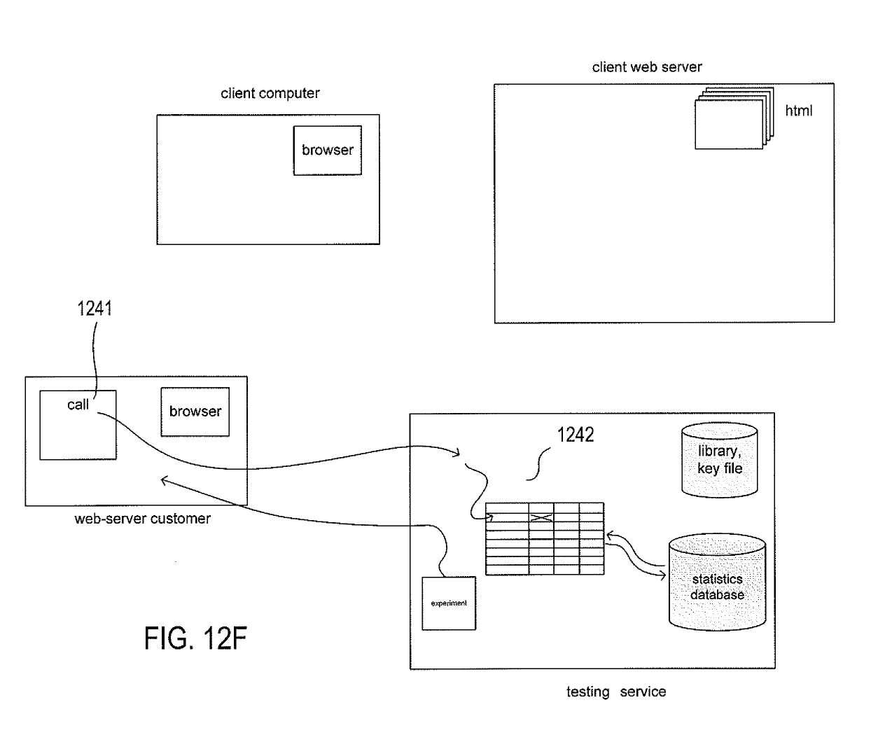

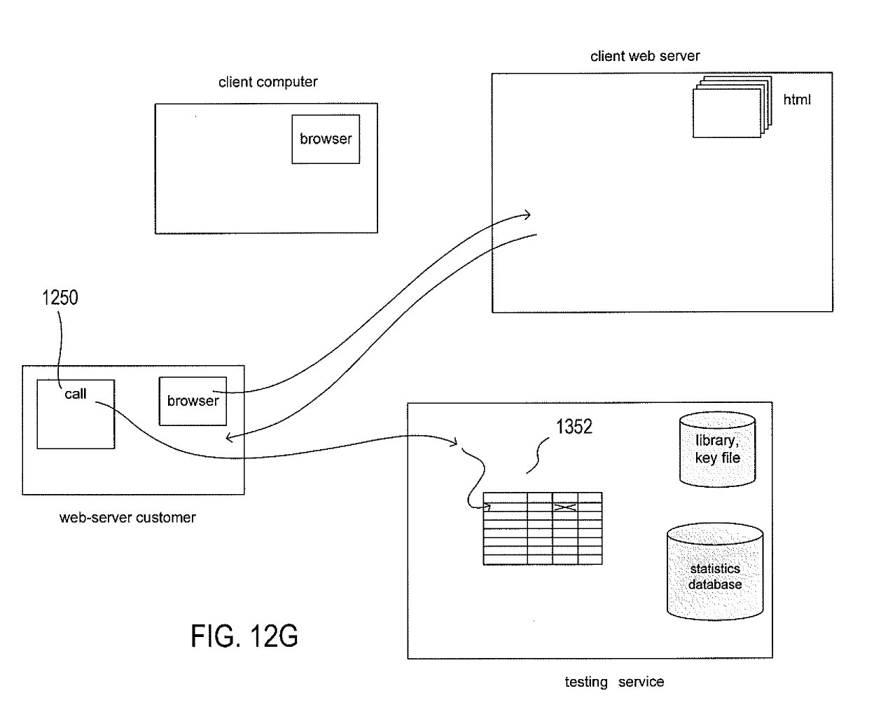

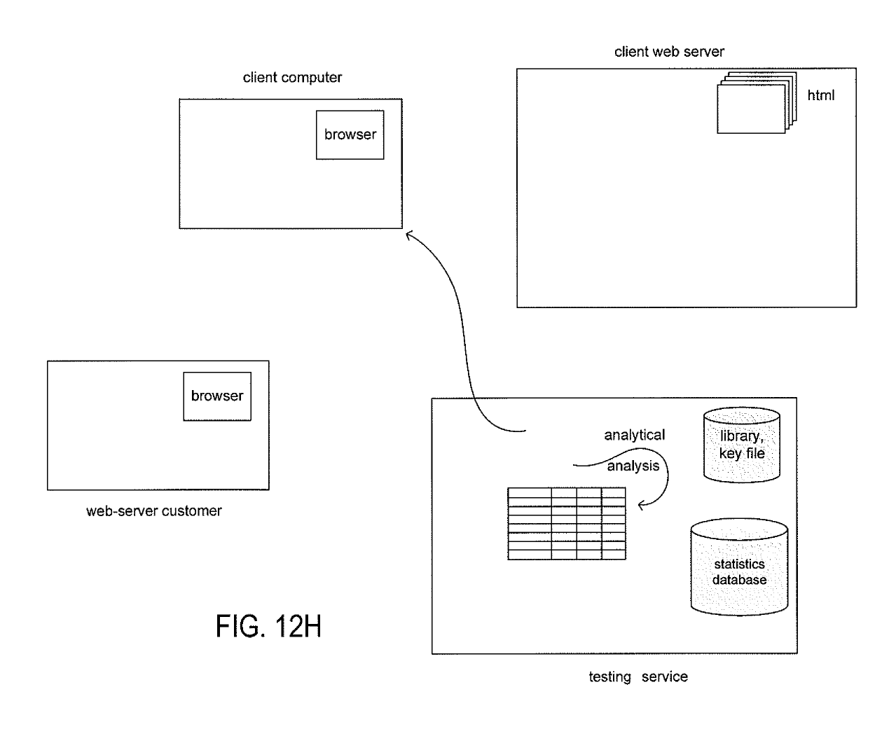

FIGS. 12A-H illustrate a general method and system for web-site testing. FIGS. 12A-H all use the same illustration conventions, in which large rectangles represent the four entities shown in FIG. 11.

A client establishes a relationship with the analysis-and/or-testing service, as shown in FIG. 12A, by accessing the analysis-and/or-testing service through a browser executing on the client computer. As shown in FIG. 12A, an employee or owner of the client web server uses the client computer 1202 to access an analysis-and/or-testing-service web site, via a browser 1204 running on the client computer, which allows the client web server to register as a client of the analysis-and/or-testing service. The analysis-and/or-testing service 1206 includes one or more databases 1208 and 1210 that store information used to construct library and key files that are downloaded to client web servers, store statistics collected during testing, and store various different data objects and records that describe clients, tests, test runs, experiments, and other data used to conduct web-site testing. The client web server 1212 serves a number of different web pages described by HTML files 1214 to users, represented by user 1216 who access the web pages served by the client-web server through a browser 1218 running on the customer computer 1216. The analysis-and/or-testing service and client web server additionally include web-server engines, application programs, and other components of servers and computer systems (1215 and 121 in FIG. 12A).

As shown in FIG. 12B, the client carries out a dialog 1220 with the analysis-and/or-testing service in order to provide the analysis-and/or-testing service with information about the client that allows the analysis-and/or-testing service to prepare a client record or records 1222 that describe the client and to store the client record or records in the database. In addition, the analysis-and/or-testing service may undertake various authorization and authentication steps to ensure that the client web server is a valid web server and that the client can transmit remuneration for analysis-and/or-testing services to the analysis-and/or-testing service. As part of client initialization, the analysis-and/or-testing service prepares a script library 1224 and a key file 1226 that the analysis-and/or-testing service downloads to the client web server. The script library 1224 includes routines that are called by client-web-server users during web-site testing. This library is referred to as a “script library” because script routines are often provided to browsers for execution. However, other types of routines may be provided by other types of libraries. The key file 1226 includes cryptographic information that ensures that all information exchanges that occur between client users and the analysis-and/or-testing service are secure.

As shown in FIG. 12C, following client initialization, the client modifies any of the HTML encodings of web pages that may be altered during testing of the client-web server by the analysis-and/or-testing service. The alternations are minimal. To each HTML file that encodes a web page that may be tested, the client generally adds only two single-line statements and, in the case that display objects are not associated with identifiers, as discussed above with reference to FIG. 3, the client web server provide identifiers for each of the objects that may be specified as factors for testing of web pages. The single-line statements are generally identical for all client web pages, greatly simplifying the web-page modification carried out by the client. The first statement results in downloading of a script library from the client web server, and the second script launches one or more information exchanges between the testing server and user computer. In the case that a conversion event is tied to a specific user-activated display device, such as a button, a call to a conversion script is inserted into the HTML file, so that user activation of the user-activated display device generates an information-exchange transaction with the analysis-and/or-testing service corresponding to a conversion event. As discussed above, these may be the HTML identifiers discussed with reference to FIG. 3, or other types of identifiers. In many cases, simple changes to the HTML files can be automatically carried out by a script or by routines provided by a content-management-service application-programming interface.

Following client initialization and modification of the HTML-file encodings of web pages that may be subsequently tested, the client can configure and run tests through a test-configuration interface provided as a website by the analysis-and/or-testing service to clients, as shown in FIG. 12D. The test configuration interface 1230 allows the client computer to define tests 1232, specify and modify already-specified test runs 1234, and specify segments 1236, and, using client-supplied test and test-run specifications, the analysis-and/or-testing service generates the experiments 1238 associated with each test run. All of the test, test-run, and segment information is stored in records associated with a reference to the client in one or more databases within the analysis-and/or-testing service. The test-configuration interface 1230 additionally provides run-time information to the client web server and allows the client web server to launch trial runs and test runs.

When a client web server has created a test and launched a test run for the test, the analysis-and/or-testing service provides modifications of the tested web page to users of the client-web-server during the test in order that the users receive altered web pages that constitute test experiments, and the analysis-and/or-testing service collects statistics based on users' access to web pages under test. This process is next described, with reference to FIGS. 12E-G.

When a client-web-server user 1216 accesses a test web page, the client-web-server user sends an HTML-file request through the Internet to the client web server 1212, as shown in FIG. 12E, which returns the requested HTML page to the client-web-server user 1216 for rendering and display by the browser 1218 executing within the user's computer. As the browser begins to process the HTML file, the browser encounters a statement 1240 that causes the browser 1218 to request the script library from the client web server. When the script library is downloaded by the client web server, the HTML file is modified, on the user computer, to launch an additional information exchange with the analysis-and/or-testing service to download additional library routines from the analysis-and/or-testing service. This additional information exchange is carried out only when the web page being processed is an active test page, the user computer is a valid test subject for an active test, and the additional library routines are not already cached in the user computer's browser. Insertion of the library-routine-fetch statement is one of the two modifications to the HTML files corresponding to tested web pages made by the client.

Next, as the browser continues to process the HTML, as shown in FIG. 12F, the browser encounters a call to the library routine “WM.setup” 1241. When executed by the browser, WM.setup initiates one or more information exchanges with the analysis-and/or-testing service during which the analysis-and/or-testing service can access cookies and other information associated with the web page on the user's computer, and the user computer receives web-page modifications from the analysis-and/or-testing service. Cookies can be used, for example, to ensure that a test subject who repeatedly accesses a landing page receives the same experiment, or test page, each time. Only when the web page being processed by the user computer is an active test page, and the user computer is an active test subject, are web-page modifications returned to the user computer by the analysis-and/or-testing service, and information uploaded by the analysis-and/or-testing service from the user computer. When this web page and user are validated, the analysis-and/or-testing service records the page accessed by the user, an identifier of the user, and a time of access in one or more database entries 1242 and returns a snippet, representing one or more nodes or sub-trees of the DOM corresponding to the web page, to the user computer, which modifies the DOM constructed by the browser to incorporate the snippet downloaded by the analysis-and/or-testing service to the user. In other words, the analysis-and/or-testing service downloads modifications that transform the web page downloaded by the user to a particular altered web page representing an experiment. Thus, following the information transaction illustrated in FIG. 12F, the user's browser alters the DOM and displays, to the user, the altered web page corresponding to an experiment as part of the test run. The snippet is constructed or retried by the analysis-and/or-testing service based on the orthogonal-array test basis or other test design. The stored test design defines the experiments, from which the analysis-and/or-testing service selects experiments for provision to users in order to obtain a well-distributed sampling of experiments during the test. Subsequently, as shown in FIG. 12G, should the user download a page, or invoke a feature on a page, corresponding to a conversion event, the user's browser, in processing the HTML file, encounters a library call 1250 that results in an information transaction between the user and analysis-and/or-testing service. The analysis-and/or-testing service checks to ensure that the web page is a valid conversion page for an active test, that the user is a valid test subject. When all of these tests are valid, the conversion event is recorded 1352 for the experiment by the analysis-and/or-testing service.

Finally, as shown in FIG. 12H, when the analysis-and/or-testing service has collected sufficient data to consider the test run to be complete, the analysis-and/or-testing service changes the status of the test run to complete, and may then undertake analysis and reporting of the test results. The test results may be automatically returned to the client web server, or may be subsequently returned, on demand, when the client checks the status of the test run and determines that the test run has been completed.

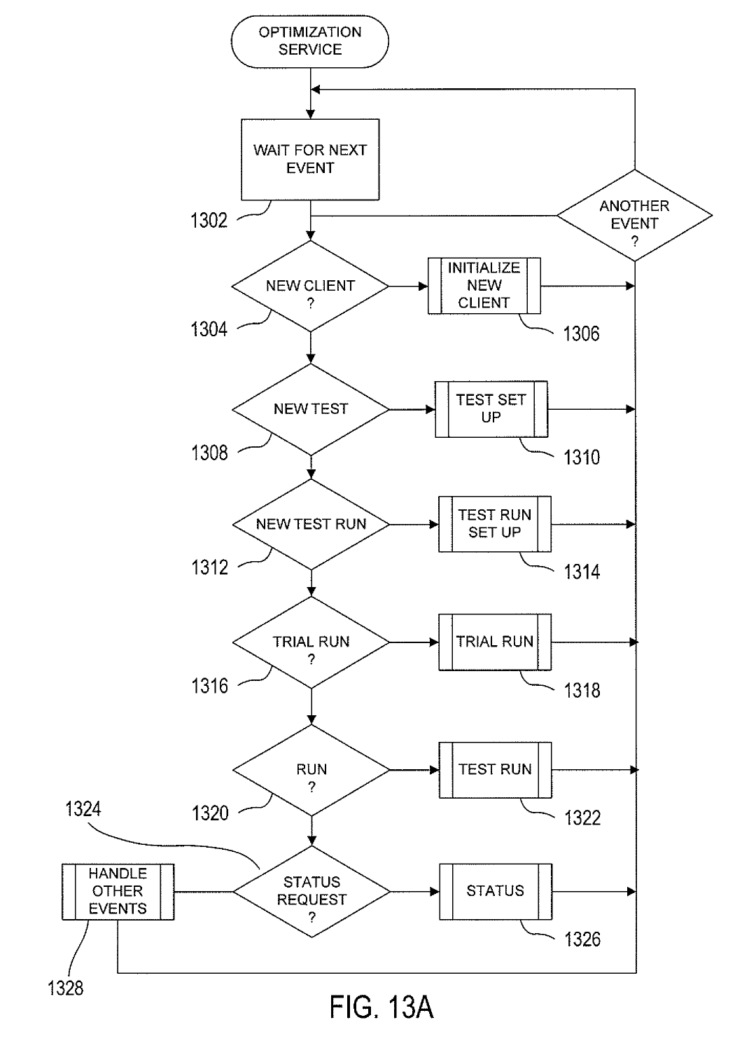

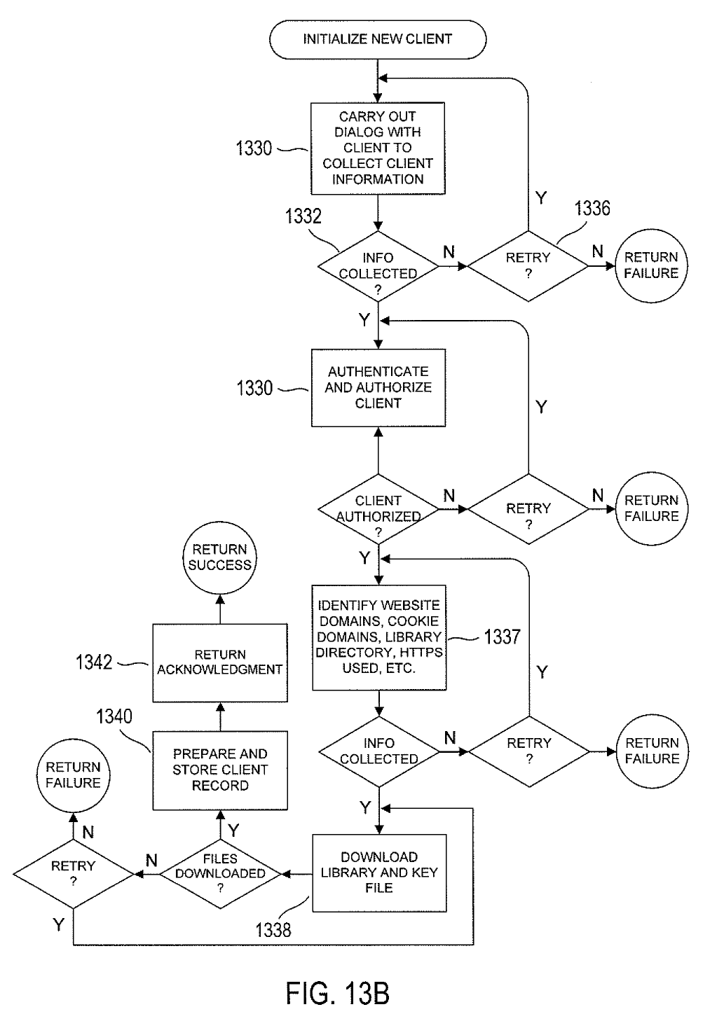

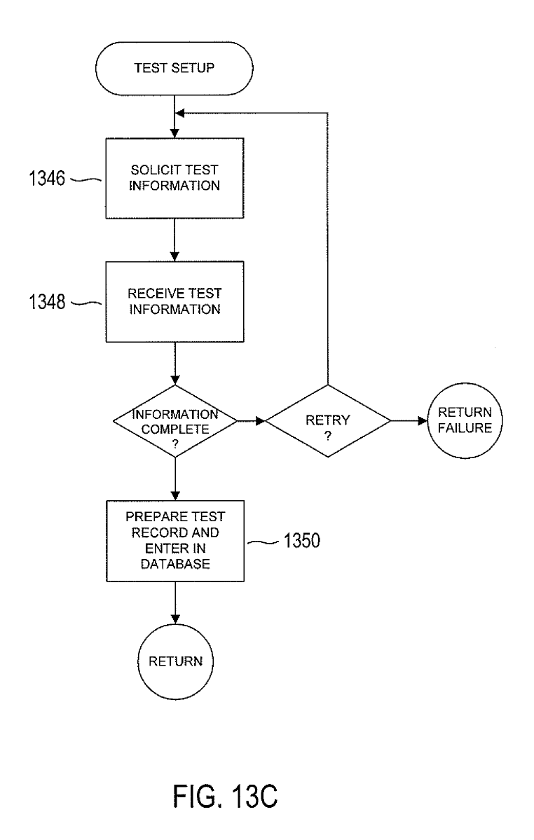

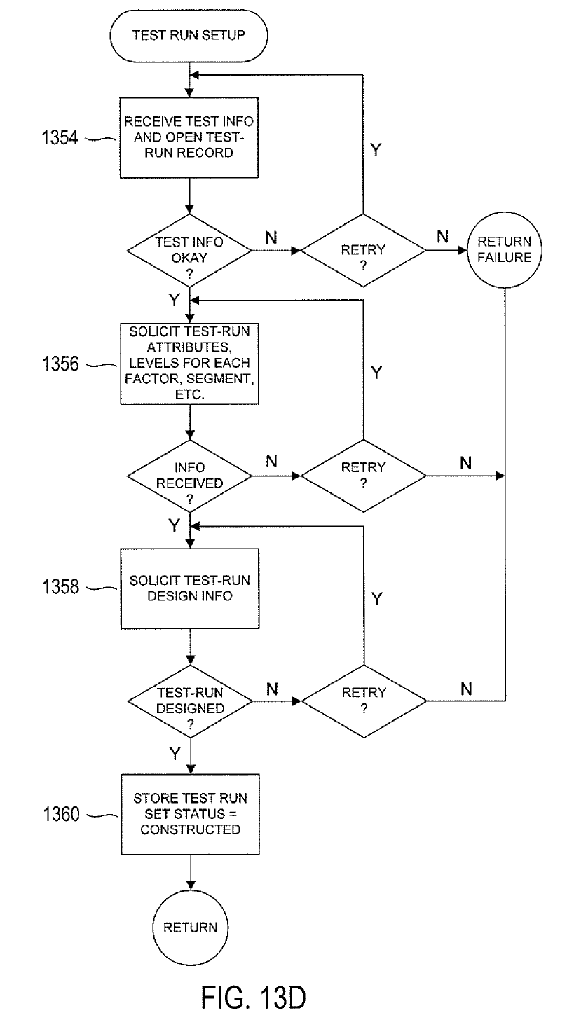

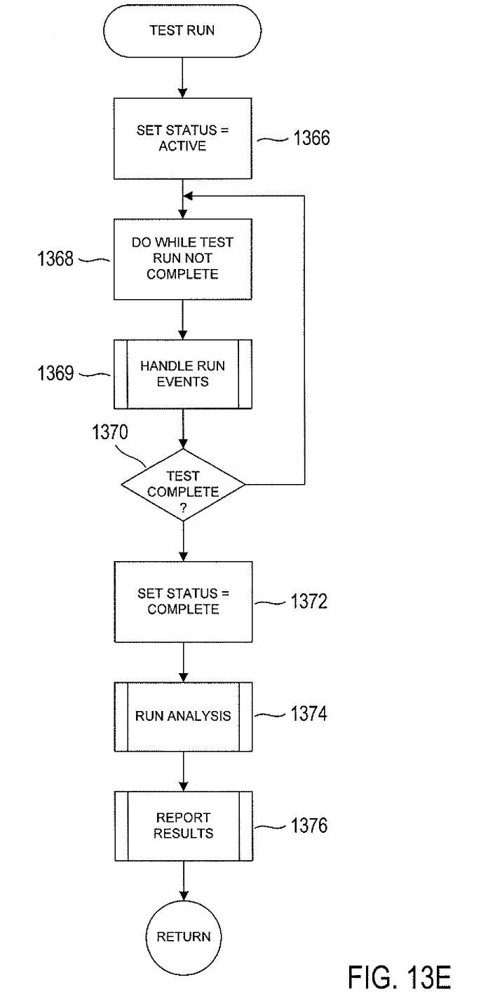

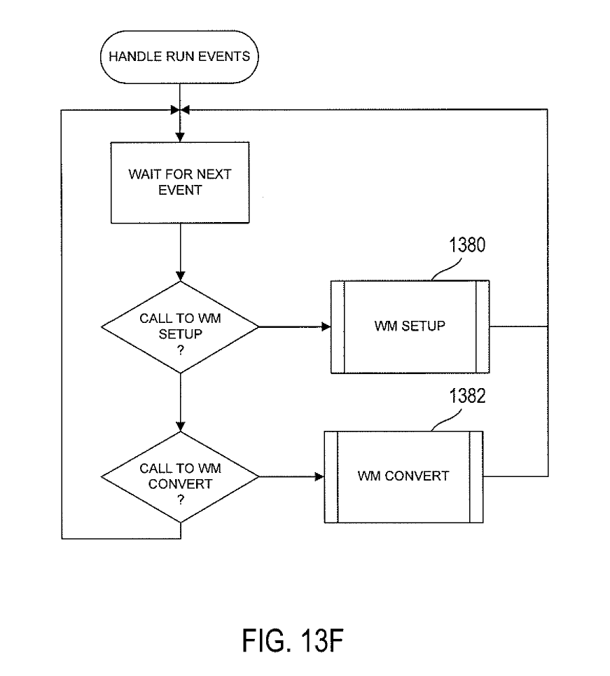

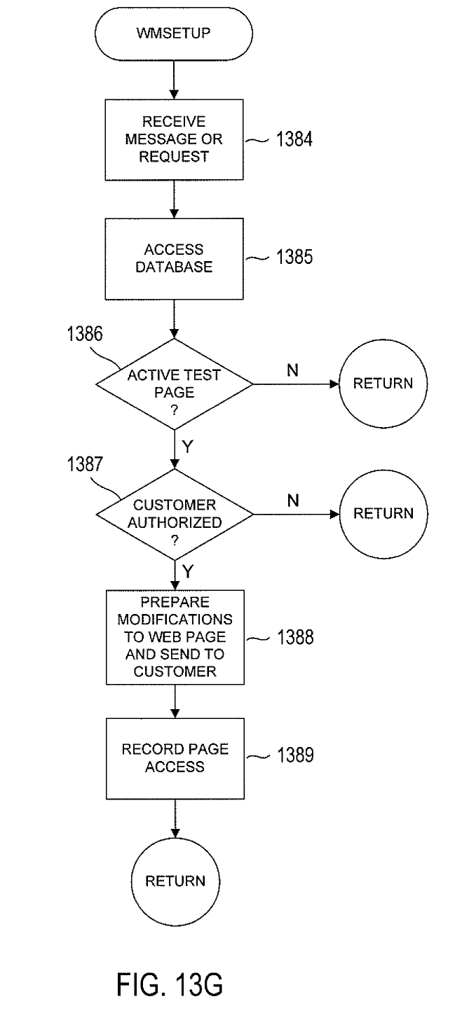

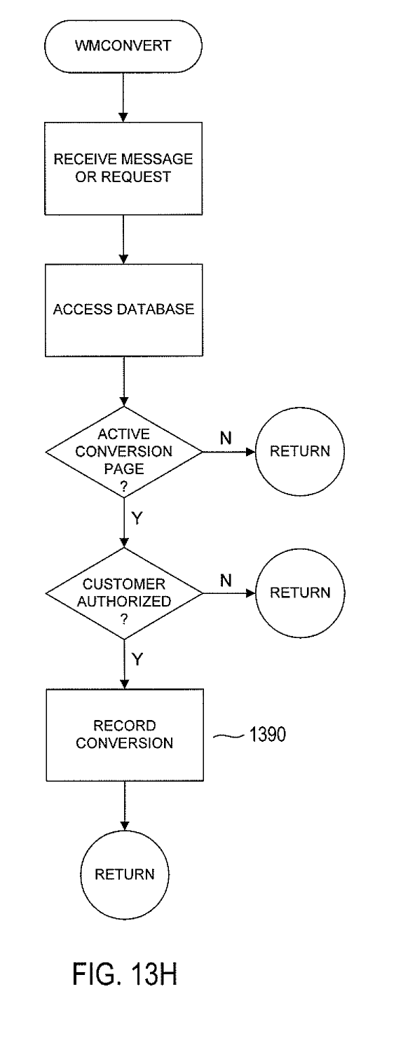

FIGS. 13A-H provide control-flow diagrams for a web-site analysis-and/or-testing service. FIG. 13A provides a high-level event loop carried out by the analysis-and/or-testing service on behalf of one or more clients. In step 1302, the analysis-and/or-testing service waits for a next client-generated event. When the event corresponds to access of the testing-service website for registration by a new client, as determined in step 1304, the routine “initialize new client” is called in step 1306. When the event is a request to construct a new test by an already-registered client through the test-configuration interface, as determined in step 1308, the routine “test setup” is called in step 1310. When the event is a request to configure a new test run, as determined in step 1312, the routine “test run setup” is called in step 1314. When the event is a request to launch a trial run, as determined in step 1316, the routine “trial run” is called in step 1318. When the event is a request to launch a test run, as determined in step 1320, the routine “test run” is called in step 1322. When the event is a status, information request, or information-update request, as determined in step 1324, then the routine “status” is called in step 1326. For example, a client can obtain test-result information during a test run, and can additional obtain analysis results following completion of a test run. Any of various additional types of events are handled in a default event handler in step 1328. Additional events include log-ons to the analysis-and/or-testing service web site by registered clients, during which clients are authorized and authenticated.

FIG. 13B provides a control-flow diagram for the routine “initialize new client” called in step 1306 of FIG. 13A. In step 1330, the analysis-and/or-testing service carries out a dialog, through the analysis-and/or-testing service web site interface, with a prospective client in order to collect information about the client. This information may include the client's name, address, billing address, web site URL, and other such information. If all needed information has been collected through this dialog, as determined in step 1332, then the analysis-and/or-testing service proceeds to authenticate and authorize the prospective client, in step 1334. Otherwise, as with most of the steps carried out by the analysis-and/or-testing service during dialogs with clients of the analysis-and/or-testing service, the analysis-and/or-testing service may elect to retry a previous step, as determined in the current case in step 1336, in order to make an attempt to acquire the remaining needed information or, in certain cases, may simply return an error message and fail. Once a client has been authorized, the analysis-and/or-testing service, in step 1337, either through a dialog or via automated methods, determines the web site domains and cookie domains of the client web server, and obtains, from the client, specification of a file-system location at which to download to the client web server the library and key files. In addition, the analysis-and/or-testing service determines whether or not to use a secure protocol when communicating with client-web-server users and any other information needed for executing tests. Then, in step 1338, the analysis-and/or-testing service creates and downloads the script library and key files to the client web server. In step 1340, the analysis-and/or-testing service prepares and stores one or more client records that describe the client and provide a basis for further interactions with the client and, finally, in step 1342, return an acknowledgement to the client. In an actual analysis-and/or-testing service system, client initialization may contain many additional steps, and may involve solicitation and acquisition of many additional different types of information.

FIG. 13C provides a control-flow diagram for the routine “test set up” called in step 1310 of FIG. 13A. In step 1346, the analysis-and/or-testing service solicits test information from the client and receives the solicited information in step 1348. Steps may be iterated in order to carry out a dialog during which the needed information to prepare and store a record describing a test is acquired by the analysis-and/or-testing service. Once the information is received, the analysis-and/or-testing service prepares a test record and enters the test record in the analysis-and/or-testing service's database in step 1350 in association with, or referenced by, one or more client records. As discussed above, test information may include a test name, creation date, description, list of factors, and other information that provide a basis for subsequent construction of test runs.

FIG. 13D provides a control-flow diagram for the routine “test run setup” called in step 1314 of FIG. 13A. In step 1354, the analysis-and/or-testing service receives information about a next test run and opens a test record for the test run. Step 1354 may involve multiple information exchanges with the client. It should also be noted that the client may elect to update or modify an already existing test run, in which case an already existing test-run record is accessed in step 1354. Next, in step 1356, the analysis-and/or-testing service carries out an information exchange with the client to obtain all the information that defines a test run, including various attributes, the levels for each factor, a specification of a test segment, and other such information. Once that information is received, then, in step 1358, the analysis-and/or-testing service provides various orthogonal-array-based or other test-design-based testing alternatives to the client, from which the client web server selects a particular test design. Various different orthogonal-array-based test designs or other types of test designs may be associated with different advantages and disadvantages, and selection of an orthogonal-array-based test or other test design may involve consideration of a number of different trade-offs, including potential length of the test run, computational requirements on the analysis-and/or-testing service, and many other such factors. Finally, in step 1360, the analysis-and/or-testing service prepares and stores a test-run record and, in addition, sets the test-run status to “constructed.” Note that an initial under-construction status may be associated with a test run as it is being defined and constructed by the routine “test run setup.”

FIG. 13E provides a control-flow diagram for the routine “test run,” called in step 1322 of FIG. 13A. In step 1366, the analysis-and/or-testing service sets the status of the test run to “active.” Then, in a continuous loop comprising steps 1368-1370, the analysis-and/or-testing service continues to handle test-run events, primarily information exchanges with test subjects' computers invoked by execution of script-library routines by users' browsers, until the test is complete, as determined in step 1370. In general, a test run continues until sufficient data has been collected to provide statistically meaningful results. However, various methods and systems provide additional means for test runs to be halted through the test-configuration interface by clients, and may provide for halting of test runs by the analysis-and/or-testing service when certain desirable events or test-run-execution characteristics are detected during the test run by the analysis-and/or-testing service. Once a test run is completed, the analysis-and/or-testing service sets the status of the test run to “complete,” in step 1372, and then may undertake analysis of the test results and reporting of results of the analysis, in steps 1374 and 1376. As briefly discussed, above, results may also be reported to a client during the test run, through the web-site interface.

FIG. 13F is a control-flow diagram of the routine “handle run events” called in step 1369 of FIG. 13E. This routine is a simple event handler, in which messages sent from user computers as a result of calls to the script-library routine “WM.setup” by user browsers are handled by a call to the routine “wmsetup,” in step 1380, and messages sent from user computers as a result of calls to the script-library routine “WM.convert” by user browsers are handled by a call to the routine “wm convert,” in step 1382. Note that the script-library routines “WM.setup” and “WM.convert” are called by a browser running on the user computer, and those script routines, in turn, call routines that initiate an information transmission with the analysis-and/or-testing service.

FIG. 130 provides a control-flow diagram of the routine “wmsetup” called in step 1380 of FIG. 13F. In step 1384, the analysis-and/or-testing service routine receives a message, for request, from a user computer as a result of execution, by a user's browser, of the script-library routine “WM.setup.” in step 1385, the analysis-and/or-testing service uses a URL for the web page being processed to access the database or databases maintained by the analysis-and/or-testing service in order to determine whether or not the call to WM.setup represents a page-access event or a conversion event, the type of test being run, whether or not the web page is an active test page and the user computer is a valid and active test subject, and other such information. When the test page that included a call to “WM.setup,” which, in turn, generated the message or request received in step 1384, is an active test page, as determined in step 1386 by the analysis-and/or-testing service, and when the user computer is an authorized test subject, as determined in step 1387, then, in step 1388, the analysis-and/or-testing service then in the case that the call to WM.setup represents a landing-page-access event, prepares the DOM modifications needed to generate an experiment for display on the user computer and transmits those modifications to the user computer. Finally, in step 1389, the analysis-and/or-testing services records either a landing-page-access event by the user computer or a conversion event, depending on the web page. Note that, in the case that the page from which the call to “WM.setup” was made is not an active test page, or in the case that the user computer is not an active and authorized test subject, the routine “wmsetup” simply returns. In other words, there is almost no performance penalty and no perturbation to the client's web server in the case that a user accesses an inactive test page or in the case that non-test-subject users access test pages. Steps 1384 and 1385 may include one or more information exchanges between the user computer and analysis-and/or-testing service.

FIG. 13H is a control-flow diagram for the routine “wmconvert” called in step 1382 of FIG. 13F. This routine is similar to the routine “wmsetup,” described with reference to FIG. 13G. The primary difference is that this routine is only called for a conversion event, which is recorded, in step 1390, as conversion event in a testing-service database.

The routine “trial run,” called in step 1318 of FIG. 13A, is similar to the routine test-run, discussed above, with the exception that a trial-run status may be set for the test run during a trial run. The routine “trial run” is not further discussed. The routine “status,” called in step 1326, returns status information with respect to test runs and other information about tests, test runs, and clients. Implementation of this routine is strongly dependent on the particular database organizations used by the analysis-and/or-testing service and on the particular web-site interface provided to clients, and is not further discussed.

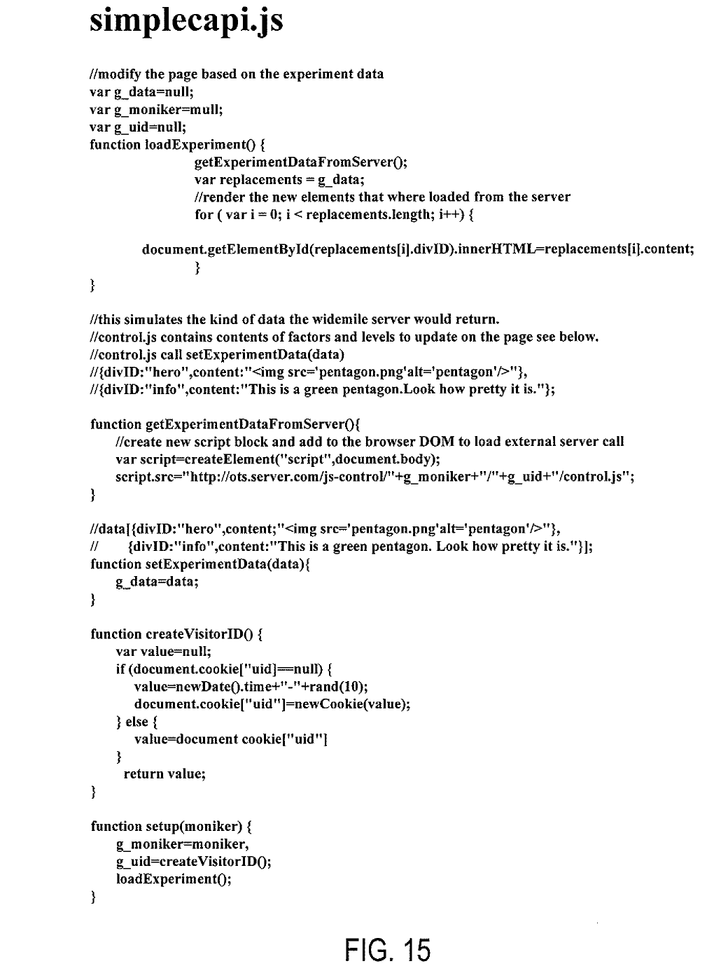

FIG. 14 shows the HTML modifications used to virtually incorporate a analysis-and/or-testing service into a web site. The HTML code, previously shown in FIG. 3, includes first statement 1402 that directs a browser to download the script-routine library and a second statement 1404 that calls a script-library entry point “WM.setup” that results in sending a message or request to the analysis-and/or-testing service to indicate a landing-page-access event or page-access-conversion event. A page that includes a displayed object, activation of which is defined to be a conversion even, is similarly modified to include a call to the library routine “WM.convert.” By merely adding two statements to an HTML file, or three in the case that the page corresponds both to a landing-page-access event and to a conversion event, the HTML file becomes a potential test web page, and the analysis-and/or-testing service is virtually incorporated into the client web server. Again, the statements used to modify landing-access-event-associated web pages are identical for all such web pages, as is the statement that is used to modify display-objects associated with conversion events. A client can easily write a script or other program, or use a content-management-system programming interface to introduce these identical statements into web pages. FIG. 15 provides an exemplary script library downloaded service.

### Interactive-Configuration, Dymanic Reconfiguration, and Auto-Configuration of Web Sites and Analysis-and/or-Testing Services for Real-Time Analysis and/or Testing

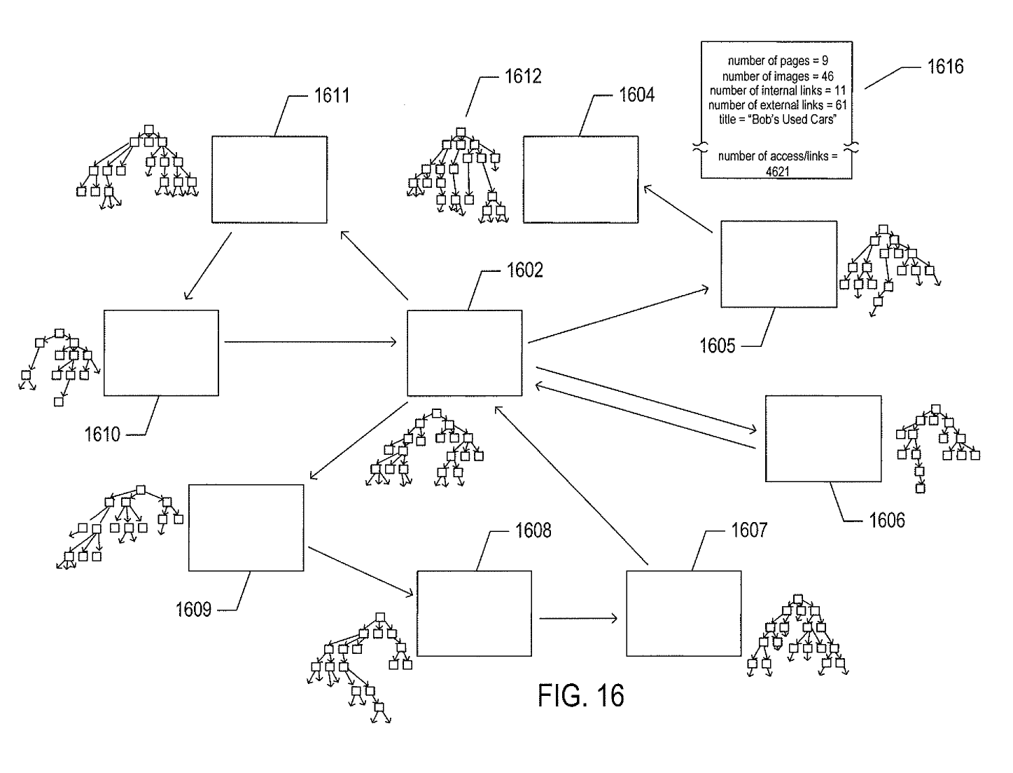

FIG. 16 illustrates the types of data that can be acquired and stored in an electronic memory or mass-storage device regarding a web site or collection of web sites that are, or are intended to be, the target of analysis or testing by a web analysis or web testing service. As discussed above, the web site comprises a home web page 1602 and potentially many different additional, linked web pages 1604-1611. The HTML-file descriptions or representations of these web pages, the DOM or other hierarchical representations of each of the web pages, and bitmap images of the rendered web pages can be accumulated and stored by well-known web-crawling and web-page rendering techniques. In FIG. 16, the DOMs for each of the web pages are shown next to the web pages, such as DOM 1612 associated with web page 1604. In addition, the web site is generally navigated by following internal links which together comprise a set of potential navigation paths through which a user may traverse the web site by standard browsing techniques. In FIG. 16, the links between web pages of the web site are shown as arrows, such as arrow 1614 representing a link from the home page 1602 to an additional page 1605 within the web site. Moreover, by web crawling and other data-processing methods, many different statistical and other characterizations for the web site can be compiled and stored, as shown in FIG. 16 as a list of text and numeric characterizations and parameters 1616. These characterizations may include counts of the number of pages within the web she, counts of the number of images included within web-site pages, counts of the number of internal links, counts of the number of external links to web-site pages, the title of the home page, and many other similar types of information. Information may also include real-time information collected as the web site is accessed by users, including the number of different accesses to the home page and other pages within particular time intervals or average numbers of accesses for multiple time intervals, the number of user-input events into web-site input features, and many other types of information.

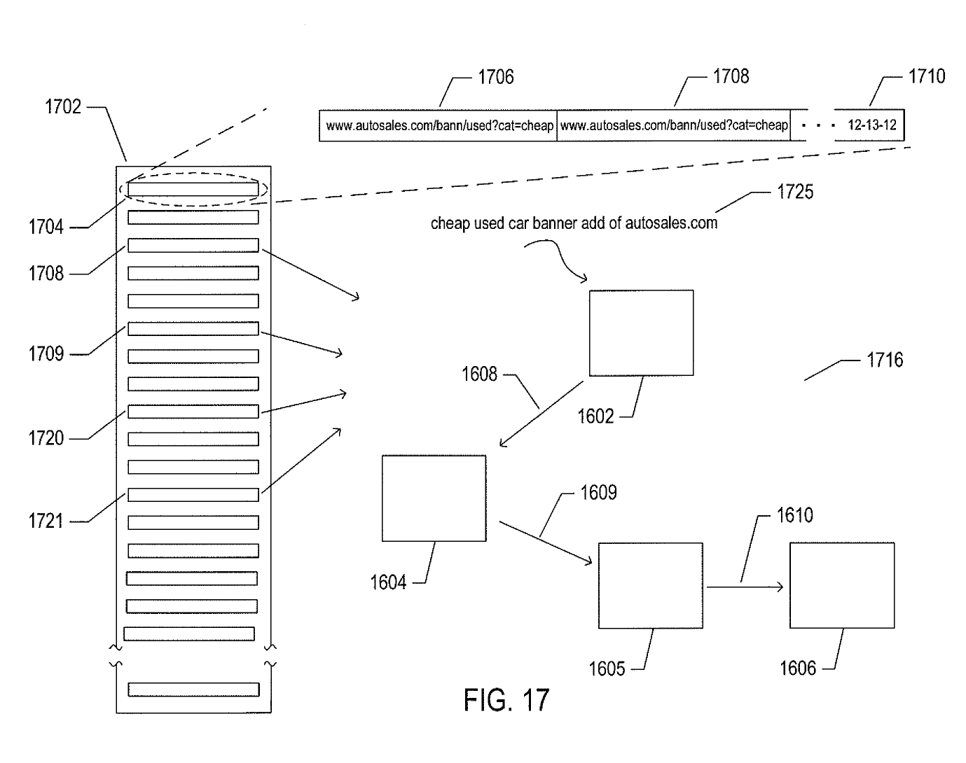

When a web site has been even minimally instrumented, or when any of various event-logging tools have been deployed to monitor computational events and activities associated with the web site, a great deal of additional information may be collected in real time with regard to operation of the web site. FIG. 17 illustrates one type of real-time information that may be acquired and stored in electronic memory or mass-storage device with regard to operation of a web site. In FIG. 17, the data is shown as being stored in an event log 1702 which includes a sequential list of event-log entries, such as event-log entry 1704. Event-log entries may include many different types of information, including the URL of the web page contained in an external link through which an Internet user arrived at a page within the web site 1706, referred to as an entry-link source, the URL corresponding to the entry link 1708, including parameters included in the URL that are passed to the web server that serves the web site, and many additional types of information, including event type and a date and time 1710 of the concurrence of the recorded event. Using the information stored within the event log, data representing a particular user's interaction with the web site 1716 can be constructed from events 1718-1721 in the event log related to the user's interaction with the web site. For example, as shown in FIG. 17, one user may have entered the web site by clicking on a banner advertisement in the autosales.com web site 1725, initially landing at the home page 1602 and then traversing additional web site pages 1604-1606 through links 1608-1610. Depending on the information maintained in the event logs that is captured from web-site activities, such reconstructed user interactions may have varying degrees of accuracy. However, even when not completely accurate, the aggregate cumulative constructions of many user interactions over periods of time may provide accurate representations of web-site operation.

A web-analytics and/or web-testing service that analyzes and/or tests web sites using real-time data acquired by instrumentation of the web sites, as discussed above, generally, as also discussed above, provides an analytics user interface to organizations and individuals who design and launch analyses and testing of web sites, as also discussed above. The analytics user interface allows users to specify web sites, portions of web sites, and aggregations of web sites and portions of web sites for analysis and testing, allows users to select particular features with respect to which data is collected and/or testing undertaken, and to provide characterizations of the web site to facilitate analysis, such as specifying conversion pages and/or features and particular web-site entry points and passed-parameter values used to identify events related to campaigns, and many other types of user-specified parameters, characterizations, and other analytics and testing inputs. In many traditional Internet-based and on-line services, such information is manually input by users using cumbersome forms and text entry or by inputting formatted configuration files, employed to manually configure one or more analyses or testing sessions. The current application is directed to alternative types of analytics and testing configuration, including interactive configuration, dynamic reconfiguration, and auto-configuration, provided by web-analysis and web-testing services and implemented as a variety of interactive-configuration, dynamic-reconfiguration, and auto configuration interfaces and methods. These new types of configurations, interfaces, and methods, when incorporated into web-analysis and web-testing systems, produce a new type of web-analytics and/or web-testing system that provides more accurate and easily used analytics-and/or-testing configuration. The methods are implemented as physical components of web-analytics and/or web-testing systems, including electronically encoded and stored computer instructions that are executed by processors to implement the methods and interfaces. These are not abstract methods and interfaces, or methods and interfaces that can be carried out by hand.

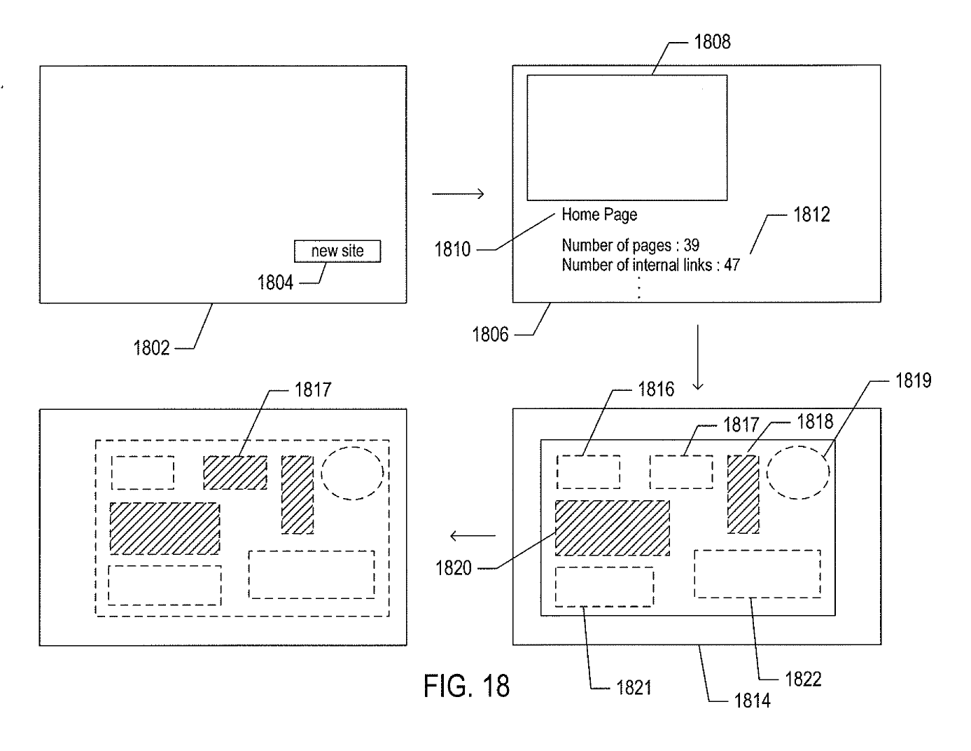

FIGS. 18-20 illustrate an example interactive-configuration session by which a user of a web-analysis and/or web-testing service configures one or more analyses or testing sessions. After logging into the web-analysis or web-testing service, and navigating to a user-interface page that includes input features to invoke interactive configuration of a web site, represented in FIG. 18 by page 1802 that includes input feature 1804 to invoke interactive configuration, the user may input the URL or other indication of a web site to interactively configure the web site and web-analysis-and/or-web-testing service for analysis or testing, as a result of which the web-analysis and/or web-testing service displays an initial interactive-configuration page 1806 for the web site. This page may provide an image 1808 of the home page, as rendered by a browser, a title 1810 of the home page, and a number of parameters and characterizations of the web site 1812 obtained by crawling the web site and accumulating a data representation of the web site, such as that illustrated in FIG. 16. Additionally, when logged information, such as that described above with reference to FIG. 17 is available, characterizations, parameters, and data gleaned from processing the logged information previously collected for the web site may allow an initial interactive-configuration page to display additional types of characterizations and data. The user may then input a command to the initial interactive configuration page that directly or indirectly leads to an interactive-configuration display for a selected page of the web site 1814. In this display, various different features gleaned from the HTML, file or DOM representation of the web page may be graphically highlighted or outlined, such as features 1816-1822, with indications as to which of the features have already been selected for instrumentation and data collection or for level-based testing, with cross-hatching used in FIG. 18 to indicate those features already selected for instrumentation. The web-page interactive-configuration page 1814 allows a user to input a mouse click or other user input to any of the outlined or highlighted features in order to select a feature for instrumentation and data collection. For example, in FIG. 18, a user may input user input to the outlined or highlighted feature 1817 in order to select that feature for instrumentation, resulting in the displayed feature being visually altered to indicate that it has been instrumented, as shown in FIG. 18 in a subsequent illustration of the web-page interactive-configuration page 1824.

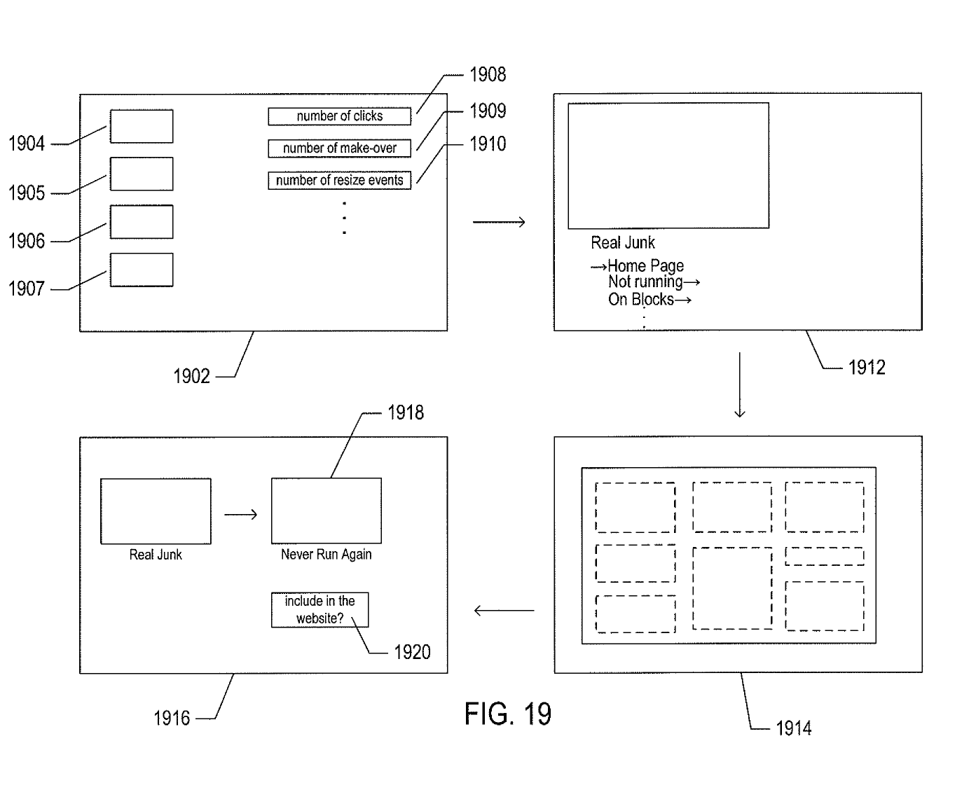

When a feature, such as feature 817 in the interactive configuration page 1824 in FIG. 18, is selected for instrumentation, an additional options page 1902 in FIG. 19 may be displayed to allow the user to specify either particular versions of the feature for level testing 1904-1907 or to select various types of data to be collected with respect to the feature for analysis 1908-1910. Once a web-site page has been interactively configured, a user can input a directive in order to move on to a next page of the web site for interactive configuration 1912, leading to feature-based interactive configuration of that web page 1914. When the data representation of the web site indicates that the web page includes links to external web pages, the web-analytics and/or web-testing service may display a page 1916 that shows an image of the rendered web page represented by the external link 1918 and that provides the user with an option to include that web page within the web site being interactively configured 1920.

For any particular web site, the web-analytics and/or web-testing service may display an image of the rendered web page 2002 within a conversion-selection interactive-configuration page 2004 along with images of other web-site pages 2006-2012 to allow the user to select a conversion page and/or conversion feature within the conversion page 2014 to associate with the web page for testing purposes. Additionally, the user interface may provide a campaign page that allows a user to interactively configure a new campaign 2016. One example of a new-campaign page includes an image of the rendered web page 2018 from the web site as well as a list of entry-link sources 2020 gleaned from an event log or other collected data as well as a list of parameters included in the URL for the web page through which users enter the web page 2022. A user can then select parameters 2024 and/or entry-link sources 2026 as well as a name for the new campaign 2028 in order to interactively configure a campaign with respect to which analysis results will be provided by a web-analysis service.

The example interactive-configuration user interface illustrated in FIGS. 18-20 is but a small portion of one possible interactive-configuration user interface. The types of displays, user inputs, and configuration options may widely vary, depending on the web-analysis and/or web-testing services provided by a web-analysis and/or web-testing service system, the type of web site that is being interactively configured, and on many different possible design and implementation parameters and decisions. In all cases, however, the interactive-configuration user interface and underlying method and system rely on a stored-data representation of a web site, as discussed above with reference to FIG. 16, and may also rely on information gleaned from event logs or other data collected during web-site operation, as discussed above with reference to FIG. 17. This information is used to identify features, web pages, and other entities that can be configured by a user for real-time data collection and subsequent analysis and provide configuration choices to the user in easy-to-manipulate, easy-to-understand graphical presentations, such as those shown in FIGS. 18-20.

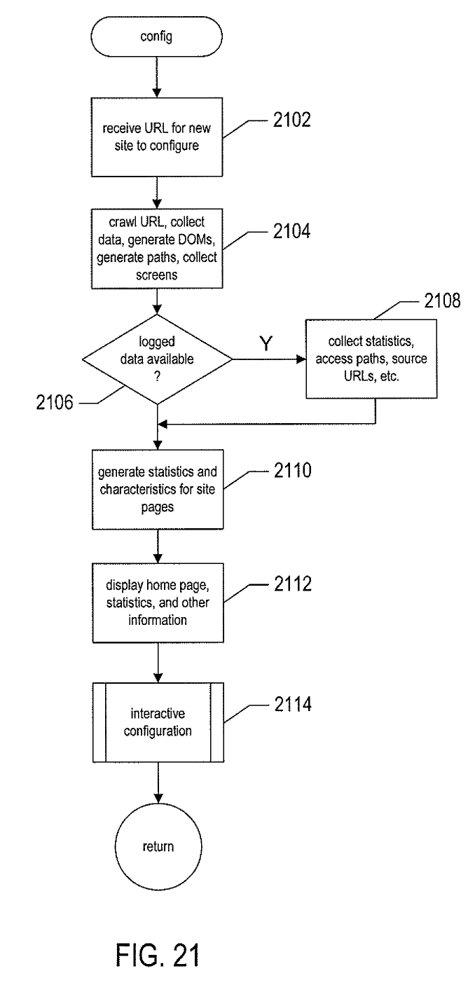

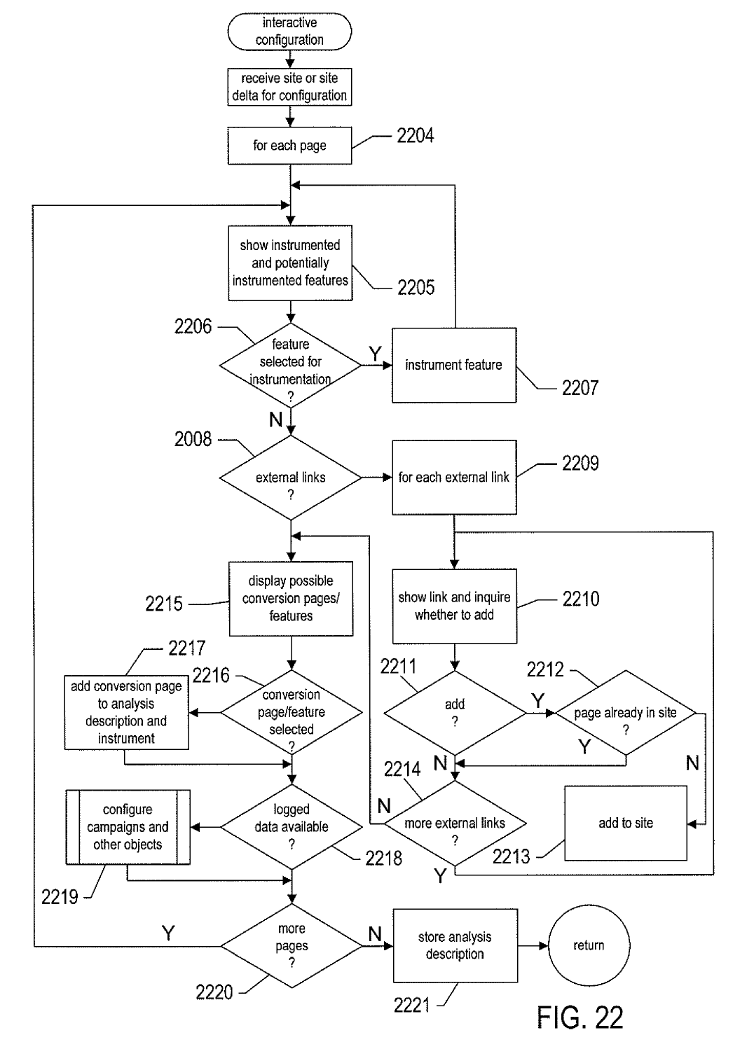

FIGS. 21 and 22 provide flow-control diagrams that illustrate interactive configuration of a web site for analysis and/or testing. In step 2102, an analysis or testing service receives the URL or other representation of a new web site to interactively configure for analysis and/or testing, generally through an interactive-configuration user interface such as that described in FIGS. 18-20. In step 2104, the analysis and/or testing service uses well-known web-crawling techniques to crawl the web site, collect various types of data with respect to the web site, generate DOMs or other hierarchical representations of the contents of web pages of the web site, generate navigational paths within the web site, render and store images of the web page of the web site, and collect other information to construct and store a data representation of the web site such as that discussed above with reference to FIG. 16. In step 2106, the analysis and/or testing service determines whether or not there is additional log data for the web site, such as the log data discussed above with reference to FIG. 17. When such data is available, the analysis and/or testing service collects statistics, generates user interactions, and collects and stores information related to user interactions, as discussed above, in step 2108. In step 2110, the web analysis and/or testing service generates the statistics and characterizations of the web site discussed above with reference to item 1616 in FIG. 16. Next, in step 2112, the analysis and/or testing service displays an initial interactive-configuration page, such as page 1806 in FIG. 18, which includes a display of the home page, statistics, and other information with respect to the web site. Then, in step 2114, the analysis and/or testing service calls the interactive-configuration routine next discussed with reference to FIG. 22.

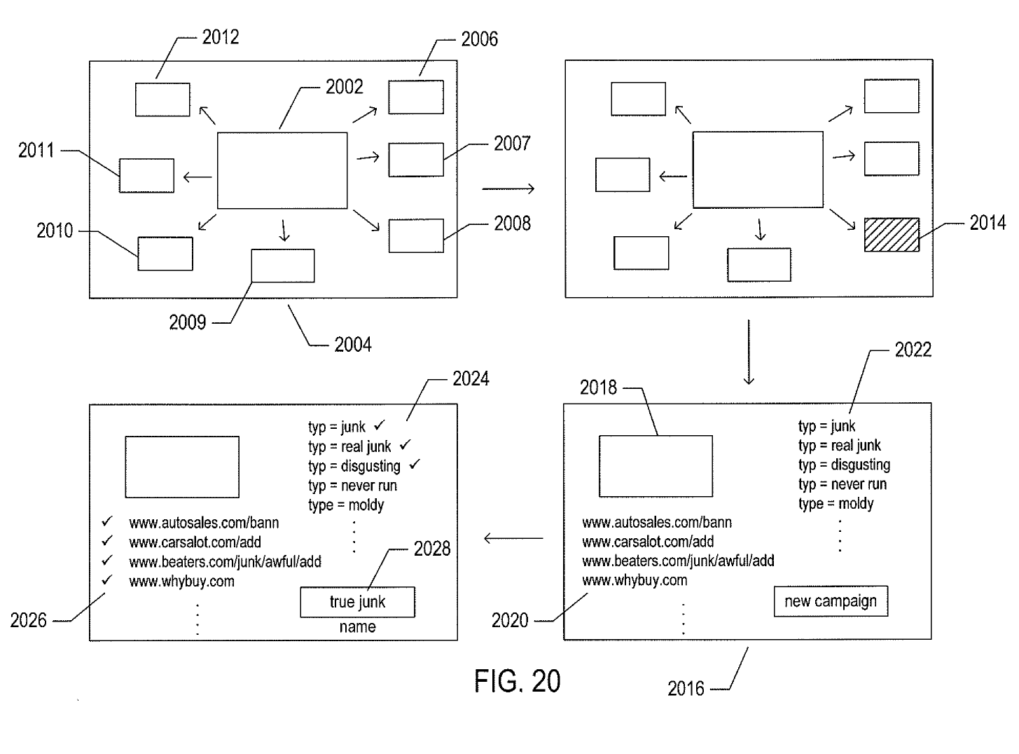

The interactive-configuration routine, illustrated in FIG. 22, receives a data representation of a web site, and additional information, or a set of delta information for the web site that represents newly added pages, features, and other entities within the web site, and then carries out user-controlled interactive configuration of all of the pages in the data representation in the for-loop of steps 2204-2221. For each page, the routine shows the instrumented and potentially instrumented features of the page, as in the web-page interactive-configuration pages 1814 and 1824 in FIG. 18. When a user selects one of the displayed features for instrumentation, as determined in step 2206, instrumentation is added to the web page in step 2207. When the currently considered page includes external links, as determined in step 2208, in the inner for-loop of steps 2209-2214, the routine shows each link and inquires of the user whether or not to add the web page represented by the link to the web site that is currently being interactively configured. The web page is only added when, as determined in step 2212, the web page has not already been included in the web site. In step 2215, the routine displays possible conversion pages and features for the web page and, when a user selects a page and/or feature as a conversion page and/or feature web page, as determined in step 2216, implementation is added, as necessary, in step 2217. Alternatively, description of the analysis configuration may be updated in order to record conversion events with respect to the web page. When live data is available, as determined in step 2218, or other such data gathered during operation of the web site, an additional set of pages, such as page 2016 in FIG. 20, may be invoked in step 2219 to configure campaigns and other types of analysis objects. When interactive configuration is complete, as determined in step 2220, the entire analysis description, or configuration, is stored in electronic memory and/or mass-storage devices in step 2221 to control subsequent analysis or testing of the web site by an analysis and/or testing service. Instrumented web pages may then be returned to the user for incorporation into the web site or otherwise incorporated within the web site in order to provide for real-time analysis, as discussed above.

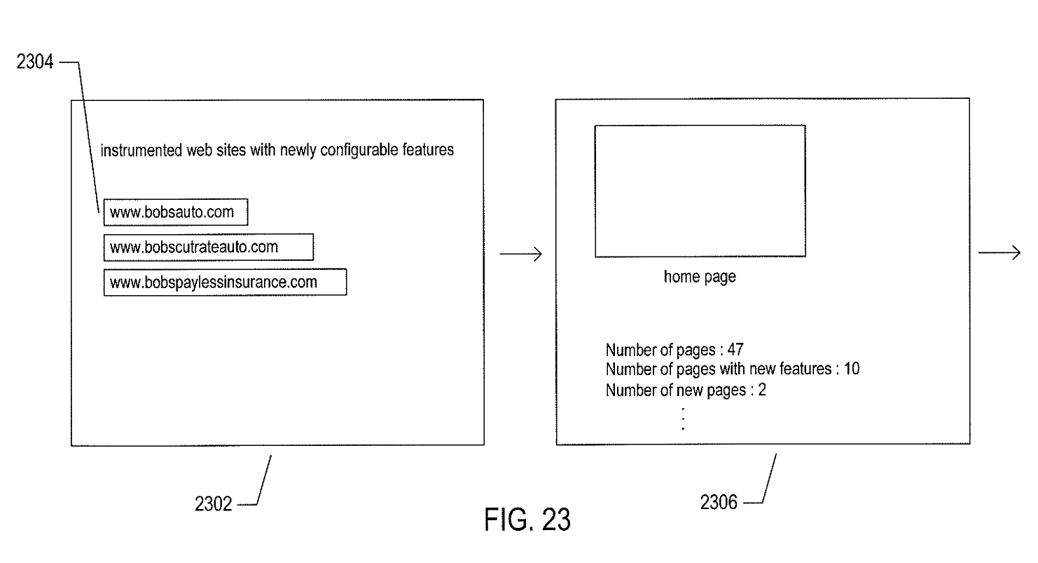

Analyses and testing may be undertaken over relatively long periods of time for a particular web site. During that time, the web site may be altered, with new pages and features added that represent additional opportunities for data collection, analysis, and testing. Dynamic reconfiguration allows users of analysis and/or testing services to be provided opportunities to reconfigure web sites for analysis and/or testing after the web sites have been initially configured for analysis and/or testing. FIG. 23 illustrates an example dynamic-reconfiguration user interface to facilitate dynamic reconfiguration. When a user next logs into an analysis and/or testing service, the analysis and/or testing service can again analyze each of the user's web sites in order to generate a new data representation of the web site and compare the new representation with the previously generated and stored representation in order to determine whether or not additional pages and features have been added to the web site since the web site was last configured. Alternatively, the analysis and/or testing service may analyze the web site and generate a delta-data representation of new pages and features linked to, or otherwise associated with, the original data representation, such as the data representation shown in FIG. 16. The analysis and/or testing service then displays a user-interface page 2302 that indicates those configured web sites which include newly configurable features. Upon user input to one of the indications of web sites with newly configurable features, such as indication 2304, the analysis and/or testing service invokes an interactive-configuration session, with initial interactive-configuration page 2306, to interactively configure any of the new web pages features that have been added since the web site was last configured.

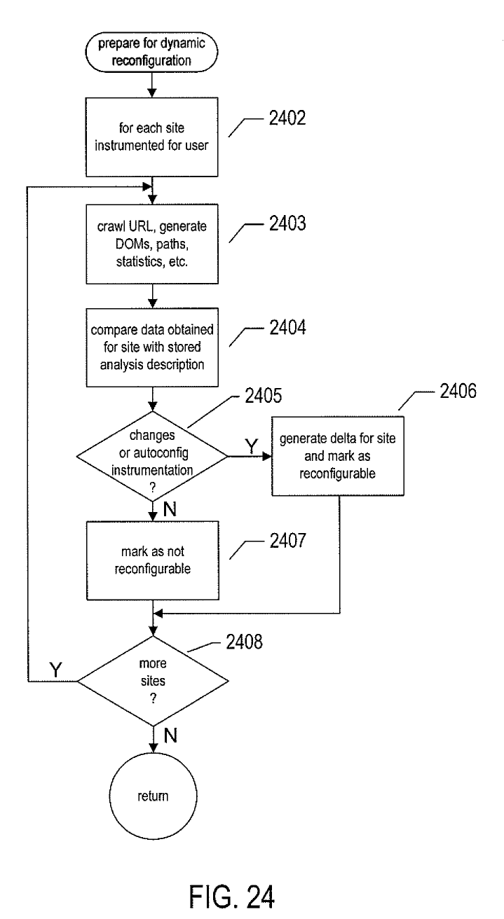

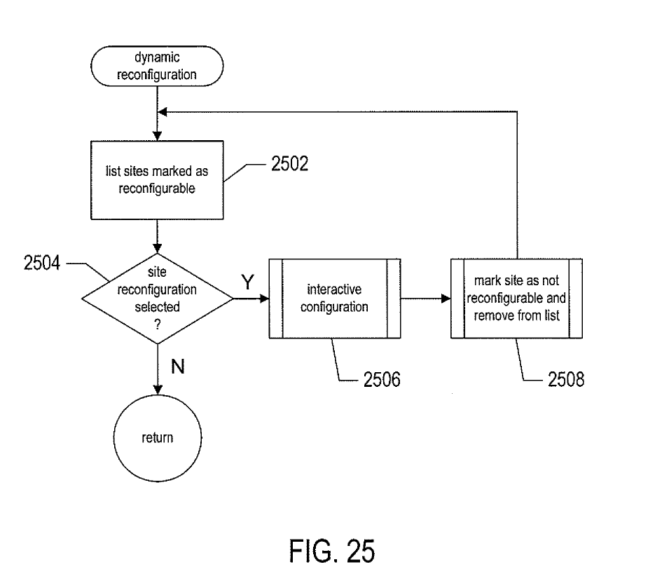

FIGS. 24-25 provide control-flow diagrams that illustrate dynamic reconfiguration. In the for-loop of steps 2402-2408, the analysis and/or testing service considers each site that has been instrumented for a user. In step 2403, the analysis and/or testing calls the site, generates DOMs, screen displays, statistics, and other such data and, in step 2404, compares the data obtained in step 2403 with the stored analysis description for the web site, including the stored data representation for the web site. When the analysis and/or testing service determines that changes or additional auto-configuration instrumentation, discussed below, are present, the analysis and/or testing service generates a delta representation for the site and marks the site as reconfigurable, in step 2406. Otherwise, the site is marked as not reconfigurable, in step 2407. Then, turning to FIG. 25, the analysis and/or testing service lists all sites marked as reconfigurable, in step 2502, in a dynamic-reconfiguration page such as page 2302 in FIG. 23. For any site that is selected for reconfiguration, as determined in step 2504, the analysis and/or testing service calls the interactive-configuration routine, in step 2506, passing the delta information representing changes to the site and auto-configuration-suggested instrumentation that comprise new opportunities for user-selectable instrumentation and then marks the site as reconfigurable and removes the site from the list of reconfigurable sites in step 2508.

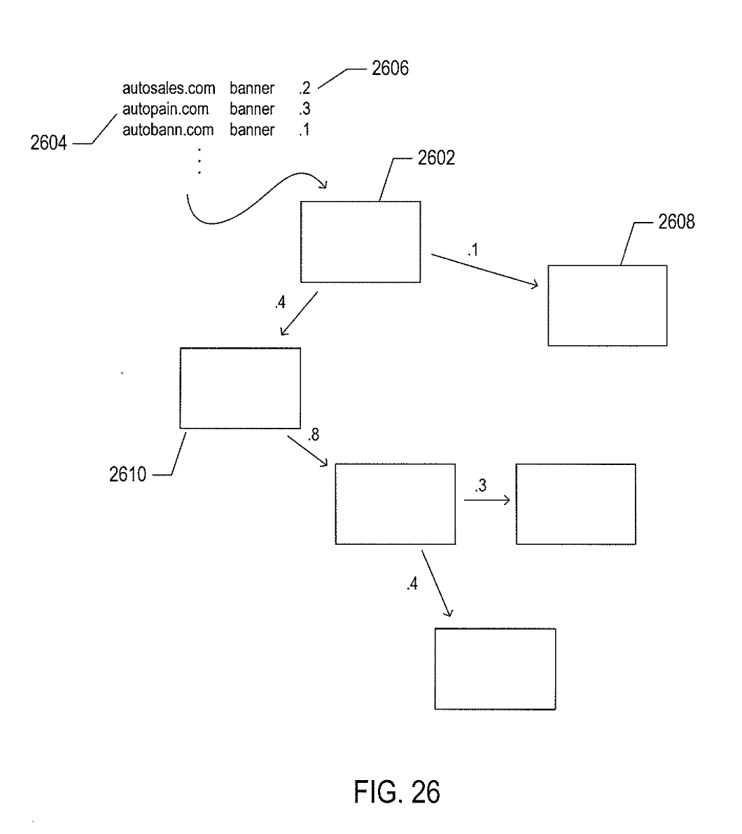

FIG. 26 illustrates the product of analysis of the third user interactions and other analyses of the logged data and other data collected during web-site operation discussed above with reference to FIG. 17. Each page in the web site that is reachable through external entry links that can be characterized statistically as shown in FIG. 26. In FIG. 26 a web page 2602 reached through external entry external entry links is shown as the root of a navigation tree. All possible paths from the page to other web site pages are shown, along with numerical indications of the percentage of accesses that lead to navigation along the navigation paths. Additionally, sources of external entry links are tabulated along with numeric indications of percentage of accesses to the web page associated with each of the sources of external entry links 2604. For example, as shown in FIG. 26, web page 2602 of the web site is accessed from an advertising banner on the autosales.com web site 20 percent of the time 2606. Once web page 2602 has been accessed, users navigate, ten percent of the time, to web page 2608 and, 40 percent of the time, to web page 2610. This type of data, which can be obtained by analysis of the logged data and other web-site-operational data, can allow an analysis and/or testing service to auto configure campaigns, conversion pages and/or features, and new features and new pages detected by web-site analysis and comparison with stored web-site data representations, such as those discussed in FIG. 16.

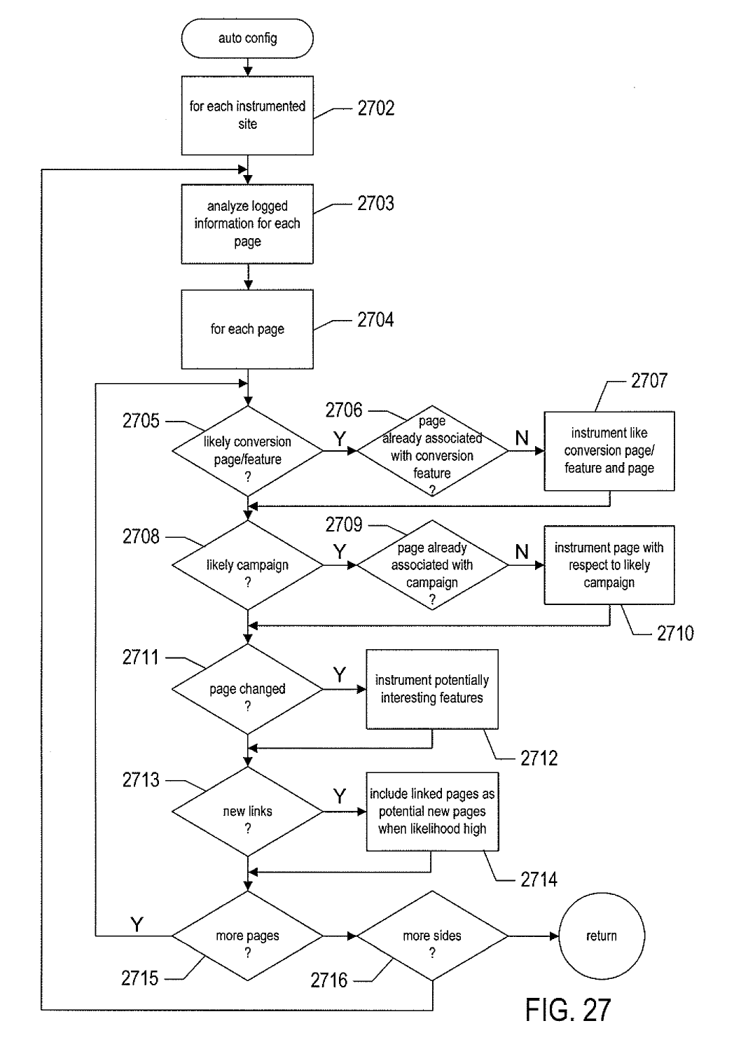

FIG. 27 provides a control-flow diagram for an auto-configuration routine that may be periodically or continuously run by an analysis and/or testing service. In the for-loop of steps 2702-2715, each instrumented web site for a particular user or account is considered. In step 2703, the logged information for each page of the web site is analyzed to generate analysis results, such as those shown in FIG. 26 for a particular web page of a web site. Traditionally, a web site may be analyzed to produce a representation, such as that shown in FIG. 16, or a representation of the delta differences between the current web site and the stored data representation for the web site. Next, in the for-loop of steps 2704-2715, for each page in the currently considered instrumented site, auto-configuration instrumentation is added, when justified. For example, if a likely conversion page or feature of a particular web page can be discerned from data, such as that shown in FIG. 26, and the likely conversion page or feature is not already identified, as determined in step 2706, then, in step 2707, instrumentation is added to the web page or indications are added to the analysis description, or both, to configure collection of conversion data based on the likely conversion page. When, as determined by considering analysis or results, such as the compiled analysis result shown in FIG. 26, the web site is a 26, the web site is a likely landing page for an advertising campaign, and the web page is not already associated with a campaign, instrumentation is added to the web page and/or stored analysis indications are added to the analysis description in order that data be collected with respect to a campaign associated with the web page. When the page has been altered since last configured, as determined in step 2711, then new features may be instrumented, in step 2712, to collect data that can be subsequently analyzed should those features eventually be configured by users. Similarly, if new links are detected on the page, as determined in step 2713, then the linked pages may be added as potential new pages of the web site, in step 2714. All of the changes, including additional instrumentation and changes to the stored analysis and/or testing configuration, are marked as auto-configuration changes. While data is collected for auto-configuration-determined features, pages, campaigns, and other such objects, the data is retroactively incorporated within analyses produced by the analysis and/or testing service when the features or pages are subsequently configured by a user during dynamic reconfiguration.

Although the present invention has been described in terms of particular embodiments, it is not intended that the invention be limited to these embodiments. Modifications within the spirit of the invention will be apparent to those skilled in the art. For example, many different implementations of interactive configuration, dynamic reconfiguration, and auto configuration for testing and/or analysis services can be obtained by varying any of many different implementation parameters, including modular organization, programming language, operating system, control structures, data structures, and other such implementation parameters. Interactive configuration, dynamic configuration, and auto configuration are all intended to provide easy, user-friendly configuration tools that facilitate a user identifying pages, features, and other aspects of a web site for implementation. Dynamic reconfiguration allows users to reconfigure web sites during analysis and testing or prior to subsequent analysis and testing, so that potentially expensive and time-consuming analyses and tests are not wasted by ignoring newly added pages, features, and other entities to a web site. Similarly, auto configuration proactively collects data in the event that entities identified by auto configuration are subsequently configured by users.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A web-site analytics system comprising:
an analytics component that collects data from instrumented web pages of a web site during real-time access to the pages; and
a configuration component that configures pages of the web site and the analytics component for data collection and analysis, the configuration component including
an interactive-configuration component that generates a data representation of the web site and then provides an interactive configuration interface through which a user can select pages and features on pages for instrumentation;
a dynamic-reconfiguration component that determines when a web site has been altered, following initial configuration, and invokes the interactive-configuration component to allow a user to select new pages and features for instrumentation; and
an auto-configuration component that detects, during web-site operation, new pages, features, and potential campaigns and conversion pages and features and instruments web pages and alters stored configuration to collect data with respect to the new pages, features, and potential campaigns and conversion pages and features.
